(19) United States
(12) Patent Application Publication
(10) Pub. No.: US 2019/0130349 A1
(43) Pub. Date: May 2, 2019

(54) AUTONOMOUSLY OPERATED MOBILE LOCKER BANKS

(71) Applicant: United Parcel Service of America, Inc., Atlanta, GA (US)

(72) Inventors: Jerome Ferguson, Princeton, NJ (US); Jeffrey Cooper, Atlanta, GA (US)

(21) Appl. No.: 15/798,025

(22) Filed: Oct. 30, 2017

(51) Int. Cl. G06Q 10/08; G05D 1/02; G01C 21/34

(52) U.S. Cl. CPC G06Q 10/0833; G01C 21/343; G05D 1/0202; G05D 1/0278

(57) ABSTRACT

A mobile locker bank system for providing parcel pickup/delivery at various locations is provided. A mobile locker bank can be automatically routed and travel to a location to facilitate pickup/delivery of parcels. Further, the mobile locker bank system may expand capacity of a fixed locker bank having monitors when the number of available lockers drops below a predefined threshold capacity at the fixed locker bank. In response to this trigger, a mobile locker bank is automatically routed to the fixed locker bank to increase a number of available lockers at the location. Each locker bank further includes a communication system that is adapted to facilitate direct or indirect communication between the fixed locker bank computing system and the mobile locker bank computing system when the mobile locker bank is positioned adjacent the location of the fixed locker bank.

### BACKGROUND

Fixed locker bank systems have a finite number of lockers. If all of the lockers within the fixed locker bank are housing items, users must wait for a locker to become available before using the locker bank. Additionally, fixed locker banks are generally designed to be in a fixed or static location, which does not provide flexibility to the carrier or the customers as far as drop off or pickup locations, and as such limits the ability for the carrier and/or customer to adapt to changing environmental and logistic concerns. Accordingly, there is a need for improved systems and processes for dynamically expanding capacity at fixed locker banks and providing capacity to new locations.

### SUMMARY

In particular embodiments, a locker bank system comprises a first fixed position locker bank positioned at a second location, a mobile locker bank, and a communications systems adapted to facilitate communications between a first computing system and a second computing system when the mobile locker bank is positioned at the second location so that the first fixed-position locker bank and the mobile locker bank functions as a single, combined locker bank. The first fixed-position locker bank comprises a plurality of fixed-position locker bank lockers. Each of the fixed-position locker bank lockers comprise a housing defining: (1) an interior storage portion that is accessible through an opening in the housing; (2) a door that is moveably mounted to the housing and moveable between (a) a first position, in which the door is positioned to prevent access to the interior storage portion through the opening, and (b) a second position, in which the door is positioned to permit access to the interior storage portion through the opening. The first fixed-position locker bank further comprises a locking system that is adapted to, for each respective one of the plurality of lockers of the fixed-position locker bank, selectively lock the respective locker's door in the first position. The first fixed-position locker bank also comprises a first computing system, which comprises: (1) at least one first computer processor; (2) a first memory operatively coupled to the at least one first computer processor; and (3) a first user interface operatively coupled to the at least one first computer processor. The first user interface is adapted for receiving information from, and communicating information to, a user. The first computing system is adapted to control access to the respective interior storage portions of the plurality of fixed-position locker bank lockers based on input received via the first user interface. The mobile locker bank comprises a plurality of mobile locker bank lockers, each of which comprise a locker housing defining: (1) an interior item storage portion that is accessible through an opening in the locker housing; (2) a locker door that is moveably mounted to the locker housing and is moveable between: (a) a first position, in which the locker door is positioned to prevent access to the locker housing's interior item storage portion through the opening in the locker housing, and (b) a second position, in which the locker door is positioned to permit access to the interior item storage portion through the opening in the locker housing. The mobile locker bank further comprises a mobile locker locking system that is adapted to, for each respective one of the plurality of lockers of the mobile locker bank, selectively lock the respective locker's door in the first position. The mobile locker bank also comprises a second computing system that comprises at least one second computer processor and second memory operatively coupled to the at least one second computer processor. The second computing system is adapted to control access to the respective interior storage portions of the mobile locker bank lockers.

According to various embodiments, a locker bank system comprises a first fixed-position locker bank positioned at a first location, a mobile locker bank, and a communications system that is adapted to facilitate communications between the first computing system and the second computing system so that, when the mobile locker bank is positioned at the first location, the first fixed-position locker bank and the mobile locker bank cooperate to function as a single locker bank. The first fixed-position locker bank comprises: (1) a plurality of first fixed-position locker bank lockers, each first fixed-position locker bank locker comprising a compartment having an opening and a door mounted to the compartment that is moveable between a first open position and a second closed position to prevent access to the compartment through the opening; (2) a first locking system that is adapted to, for each respective one of the plurality of lockers of the first fixed-position locker bank, selectively lock the respective locker's door in the closed position; and (3) a first computing system. The first computing system comprises: (1) a first at least one computer processor; (2) first memory operatively coupled to the first at least one computer processor; and (3) a first user interface for receiving information from, and communicating to, a user. The first computing system is adapted to control access to each respective compartment of the first fixed-position locker bank plurality of lockers based on input received via the first user interface. The mobile locker bank comprises a plurality of mobile locker bank lockers, each of the mobile locker bank lockers comprising a compartment having an opening and a door mounted to the compartment that is moveable between a first open position and a second closed position to prevent access to the compartment through the opening. The mobile locker bank also comprises a mobile locker bank locking system that is adapted to, for each respective one of the plurality of lockers of the mobile locker bank, selectively lock the respective locker's door in the closed position. Further, the mobile locker bank comprises a plurality of wheels that are operatively connected to the mobile locker bank to facilitate movement of the mobile locker bank between the first location and a second location. The mobile locker bank further comprises a second computing system comprising a second at least one computer processor and memory operatively coupled to the second at least one computer processor. The second computing system is adapted to control access to each respective compartment of the mobile locker bank plurality of lockers.

In various embodiments, a mobile locker bank expansion system comprises a mobile locker bank. The mobile locker bank comprises: (1) a first plurality of lockers; (2) a first locking system; (3) a plurality of wheels; (4) a first computing system; and (5) a first communication system. Each of the lockers of the first plurality of lockers comprises a locker housing defining: (1) an interior storage portion that is accessible through an opening in the locker housing; and (2) a locker door that is mounted to move between: (a) a closed position, in which the locker door is positioned to prevent access to the locker housing's interior storage portion through the opening in the locker housing, and (b) an open position, in which the locker door is positioned to permit access to the interior storage portion through the opening in the locker housing. The first locking system is adapted to, for each particular one of the first plurality of lockers, selectively lock the particular locker's door in the closed position. The plurality of wheels are operatively connected to the mobile locker bank for facilitating movement of the mobile locker bank from a first location to a second location. The first computing system comprises at least one computer processor and memory operatively coupled to the at least one computer processor, the computing system being adapted to control access to the respective interior storage portions of each of the first plurality of lockers via the locking system. The first communication system is operatively coupled to the first computing system. When the mobile locker bank is positioned at a first location at which a first fixed-position locker bank is located, the first fixed-position locker bank having a second plurality of lockers and a second computing system, the communication system is adapted to allow the first computing system to either directly or indirectly communicate with the second computing system so that the first plurality of lockers and the second plurality of lockers function as a single plurality of lockers.

In various embodiments, the mobile locker bank may be self-driving. The self-driving mobile locker bank may also be referred to as automated pickup/delivery vehicle (AP/DV). The AP/DV system, according to particular embodiments comprises at least a locker bank and a processor having computer executable instructions that, when executed by the processor, cause the AP/DV system to perform operations. Mobile locker banks, such as an AP/DV, may further comprise an unmanned vehicle (UV) communicatively coupled to the mobile locker bank, a UV parcel loading/unloading system(s), a UV launching system(s), and/or UV storage and charging systems. Further, in some embodiments, the AP/DV may comprise a detachable locker bank and an autonomous driving system. The detachable locker bank may comprise a locker bank, a mobile locker bank computer, and a coupling system. The autonomous driving system may comprise a coupling system, and a AP/DV system (e.g., guidance component) configured to operatively navigate the autonomous driving system throughout the world.

The AP/DV system may be configured to receive information associated with parcels loaded into one or more lockers. The AP/DV system may further be configured to determine at least one pickup/delivery location to, at least temporarily, locate the AP/DV. The pickup/delivery location may be based on at least one of: (1) pickup/delivery location information associated with the parcel; (2) the density of the intended delivery addresses associated with the parcels loaded into the lockers; (3) the population density of the region corresponding to the intended delivery addresses; (4) density of parking locations; (5) locations of (a) fixed locker banks, (b) detachable locker bank systems, (c) locations of parcel drop boxes, (d) sorting facilities, (e) attended pickup/delivery locations; (6) legal considerations applicable to the region in which the pickup/delivery location is to be located; and (7) user/customer demand. The AP/DV system may further be configured to determine a current location of the AP/DV and generate a first route to a pickup/delivery location. Further, the AP/DV system may substantially automatically move the AP/DV, proximate the first route to a geographic location corresponding to the first pickup/delivery location. Further, it is determined that the AP/DV is located at a geographic location proximate the first pickup/delivery location. The AP/DV system may receive an indication to pickup/deliver parcel(s) to a user.

In an exemplary aspect, an automated pickup/delivery vehicle (AP/DV) system for facilitating autonomous delivery/pickup is provided. The AP/DV system comprises a first locker bank comprising at least a first pickup/delivery locker, and a processor having computer executable instructions that, when executed by the processor, cause the AP/DV system to perform operations. The operations comprise determining a first pickup/delivery location associated with a first parcel to, at least temporarily, locate an AP/DV associated with the AP/DV system, wherein the determining of the first pickup/delivery location is at least partially based on location information of a customer associated with the first parcel. The operations further comprise determining a current location of the AP/DV, generating a first route to the first pickup/delivery location based on at least the current location of the AP/DV and the first pickup/delivery location associated with the first parcel, and generating a first set of operational instructions to control operation of the AP/DV for moving the AP/DV to the first pickup/delivery location based, at least partially, on the first route. Further, the operations comprise determining that the AP/DV is located at a geographic location proximate the first pickup/delivery location.

In another exemplary aspect, a system is provided for facilitating autonomous delivery/pickup by an unmanned vehicle. The system comprises an automated pickup/delivery vehicle (AP/DV) comprising at least a first locker bank, wherein the first locker bank comprises a first set of pickup/delivery lockers, one or more processors, and computer memory having instructions that, when executed by the one or more processors, cause the one or more processors to perform operations. The operations comprise determining a first set of parcels to be stored in the first set of pickup/delivery lockers, receiving an indication that the first set of parcels is stored in the first set of pickup/delivery lockers, and determining a first pickup/delivery location associated with a first parcel to, at least temporarily, locate the AP/DV, wherein the first pickup/delivery location is based on location information of a customer associated with the first parcel. Further, the operations comprise generating, based on the first pickup/delivery location, a first route to the first pickup/delivery location, determining a context associated with the first route, and based on the context and the first route, generating operational instructions to control operation of the AP/DV for moving the AP/DV to the first pickup/delivery location. Also, the operations comprise determining that the AP/DV is located at a geographic location proximate the first pickup/delivery location.

According to yet another exemplary aspect, a method is provided for facilitating automated delivery/pickup by an automated pickup/delivery vehicle (AP/DV) comprising a first pickup/delivery locker and a location sensor. The method comprises receiving a first indication that a first parcel is stored in the first pickup/delivery locker, and determining a first pickup/delivery location to, at least temporarily, locate the AP/DV, wherein the determining of the first pickup/delivery location is at least partially based on a location associated with the first parcel. Further, the method comprises determining a current location of the AP/DV based on data received from the location sensor, generating a first route to the first pickup/delivery location based on the current location of the AP/DV and the first pickup/delivery location, generating operational instructions to control operation of the AP/DV for moving the AP/DV to the first pickup/delivery location based, at least partially, on the first route, and determining that the AP/DV is located at a geographic location proximate the first pickup/delivery location.

According to various embodiments, a method of selectively expanding the inventory of a fixed-position locker bank comprises: (1) monitoring the number of available lockers at a first fixed-position locker bank positioned at a first location; (2) in response to determining that the number of available lockers at the first fixed-position locker has or will drop below a first predetermined threshold level, routing a mobile locker bank to the first location; and (3) facilitating communication between the mobile locker bank and the first fixed-position locker bank when the mobile locker bank is at the first location so that users may access a locker of the mobile locker bank via a user interface on the first fixed-position locker bank.

In various embodiments, a method of selectively expanding the inventory of a fixed-position locker bank is provided that includes determining at computing devices a number of parcels that shall be delivered to a first fixed-position locker bank at a first location over a time period. With the computing devices, a number of available lockers are monitored at the first fixed-position locker bank positioned at the first location. In response to determining the number of parcels to be delivered and monitoring the number of available lockers at the first fixed-position locker bank, an amount of lockers needed to hold all is calculated. If the amount of lockers exceed a total number of lockers at the first fixed-position locker bank, a mobile locker bank is routed to the first location. Communication between the mobile locker bank and the first fixed-position locker bank is facilitated when the mobile locker bank is at the first location so that users may access a locker of the mobile locker bank via a user interface on the first fixed-position locker bank.

In various embodiments, a method of selectively establishing, at least temporarily, locker capacity at pickup/delivery locations is provided that includes determining at computing devices a pickup/delivery location, determining a route from a current location to the pickup/delivery location, and facilitating pickup/delivery of parcels at the pickup/delivery location. Further, in some embodiments, the method may comprise moving a self-driving mobile locker bank (AP/DV) proximate the determined route to the pickup/delivery location and determining that the self-driving mobile locker bank is proximate the pickup/delivery location.

### BRIEF DESCRIPTION OF THE DRAWINGS

Various embodiments of a system and method for expanding the capacity of a locker bank using a mobile locker bank are described below. In the course of this description, reference will be made to the accompanying drawings, which are not necessarily drawn to scale, and wherein:

FIG. 1 is a block diagram of a locker system in accordance with an embodiment of the present system;

FIG. 2 is a schematic diagram of a computer, such as the server of FIG. 1, that is suitable for use in various embodiments;

FIG. 3 is a perspective view of a mobile locker bank system for use in the locker system of FIG. 1;

FIGS. 4A-4D depict alternate embodiments of the mobile locker bank system of FIG. 3;

FIG. 5 depicts a flow chart that generally illustrates various steps executed by a Capacity Determination Module that, for example, may be executed by the server of FIG. 1;

FIG. 6 depicts a flow chart that generally illustrates various steps executed by a Fixed Locker Bank/Mobile Locker Bank Inventory Module that, for example, may be executed by the server of FIG. 1;

FIG. 7 depicts an exemplary user experience according to various embodiments;

FIG. 8 depicts an exemplary method that generally illustrates facilitating pickup/delivery of parcels using a self-driving mobile locker bank; and

FIG. 9 depicts an exemplary environment that generally illustrates unmanned vehicle parcel pickup/delivery facilitated, at least in part, by a self-driving mobile locker bank.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

In particular embodiments, a mobile locker bank system is adapted for expanding capacity of a fixed locker bank and/or providing capacity at a location by directing one or more mobile locker banks to the first location in order to provide lockers and/or additional lockers. In various embodiments, the system may determine that the number of available lockers at the fixed locker bank has dropped or is forecasted to drop below a particular threshold number of available lockers. In response, the system may determine that the fixed locker bank needs a temporary expansion unit (e.g., a mobile locker bank having a plurality of lockers). The expansion unit may be in the form of a mobile locker bank that is either towed or driven to the location where the fixed locker bank is located. The expansion unit is temporary to aid the capacity needs at the fixed locker bank until the additional lockers are no longer needed.

Upon arrival of the mobile locker bank to the location of the fixed locker bank, an individual and/or the system may facilitate a connection between the fixed locker bank and the mobile locker bank. The connection may include facilitating an electronic wireless communication connection and/or a physical wired connection. The communication connection may allow the computing system of the fixed locker bank to communicate either directly or indirectly with the computing system of the mobile locker bank, and allow each to communicate with mobile computing devices (e.g., a tablet computer, a smartphone, or a laptop computer) and remote servers (e.g. a remote logistics server). The communication connection may also allow the fixed locker bank computer to control access to the lockers of the mobile locker bank or vice versa. The physical connection may include connecting the mobile locker bank to the fixed locker bank by an electrical cable, other mechanical coupling device and/or to a structure or other electronic connections at the location where the fixed locker bank is positioned. For example, the location where the fixed locker bank is located may include mounting devices for securing the additional mobile locker bank and providing power and a communication channel to the mobile locker bank. For example, when the mobile locker bank is towable, the mobile locker bank may be secured to the fixed locker bank.

Once the mobile locker bank has been connected to the fixed locker bank, the system may treat the lockers of the mobile locker bank as an extension of the available lockers of the fixed locker bank. For example, users desiring to deposit an item into the locker bank may use a computer of the fixed locker bank or the mobile locker bank to access a locker within either the fixed locker bank or the mobile locker bank. In some embodiments, the system may require the user to use a computer associated with the fixed locker bank to gain access to a locker within the mobile locker bank. In other embodiments, users may also retrieve items from either the fixed locker bank or the mobile locker bank using either the fixed locker bank computer or the mobile locker bank computer.

Given the description above for the fixed locker bank and the mobile locker bank, another embodiment may be implemented where no locker bank exists. In such case, one or more mobile locker banks may be located in an area where there is no fixed locker bank. This situation can occur where there is a need for a locker bank location to facilitate the needs of users. The mobile locker bank can be used to reduce capacity demands that might exist for fixed locker banks that are located elsewhere, but not nearby or in proximity to the location where no locker bank exists. Additionally, and/or alternatively, the mobile locker bank may be positioned at different locations for a designated period of time to assess possible locations for a fixed locker bank. One or more locker banks can be towed or driven to a location. For example, during a busy holiday period or other time, one or more mobile locker banks can be towed or driven to a parking lot and positioned temporarily in the area. In the event more than one locker bank is positioned at a location, a connection may be made between the mobile locker banks. As with a connection between a fixed locker bank and a mobile locker bank, a same connection can be made between the two or more mobile locker banks where a computer of one mobile locker bank can be used to control access to all the mobile locker banks connected together at the location. This control can include gaining access to, as well as locking, the lockers in the connected two or more mobile locker banks.

In some embodiments, a mobile locker bank may be pre-loaded with packages bound for consignees in a predetermined geographic area (e.g., a neighborhood, proximate distance from anticipated parking location for the mobile locker bank). In some embodiments, unmanned vehicles, a driver, and/or agents may be dispatched to retrieve packages from the mobile locker bank and deliver packages to their associated destination addresses. The personnel may be provided an access code to gain access to one or more lockers in the locker bank. U.S. patent application Ser. No. 14/514,276, which was filed on Oct. 14, 2014 and entitled “Systems and Methods for Confirming an Identity of an Individual, for example, at a Locker Bank,” which is hereby incorporated herein by reference in its entirety, describes a driver access method that may be used in connection with this embodiment.

In some embodiments, specific lockers may contain multiple packages addressed to multiple different addresses/consignees. Accordingly, the unmanned vehicle, driver, and/or agent may gain access to a locker, retrieve at least a portion of the packages therein and deliver the packages to the associated delivery addresses/consignees. In further embodiments, the consignee may be sent notifications indicating the location of the mobile locker bank and including an access code which may be used to open a specific locker housing the associated package.

Exemplary Technical Platforms

As will be appreciated by one skilled in the relevant field, a system for using a mobile locker bank to expand capacity for accepting items at a fixed locker bank (or any other suitable location) may be, for example, embodied as a computer system, a method, or a computer program product. Accordingly, various embodiments may take the form of an entirely hardware-based embodiment, an entirely software-based embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web, mobile, wearable computer-implemented, computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Exemplary System Architecture

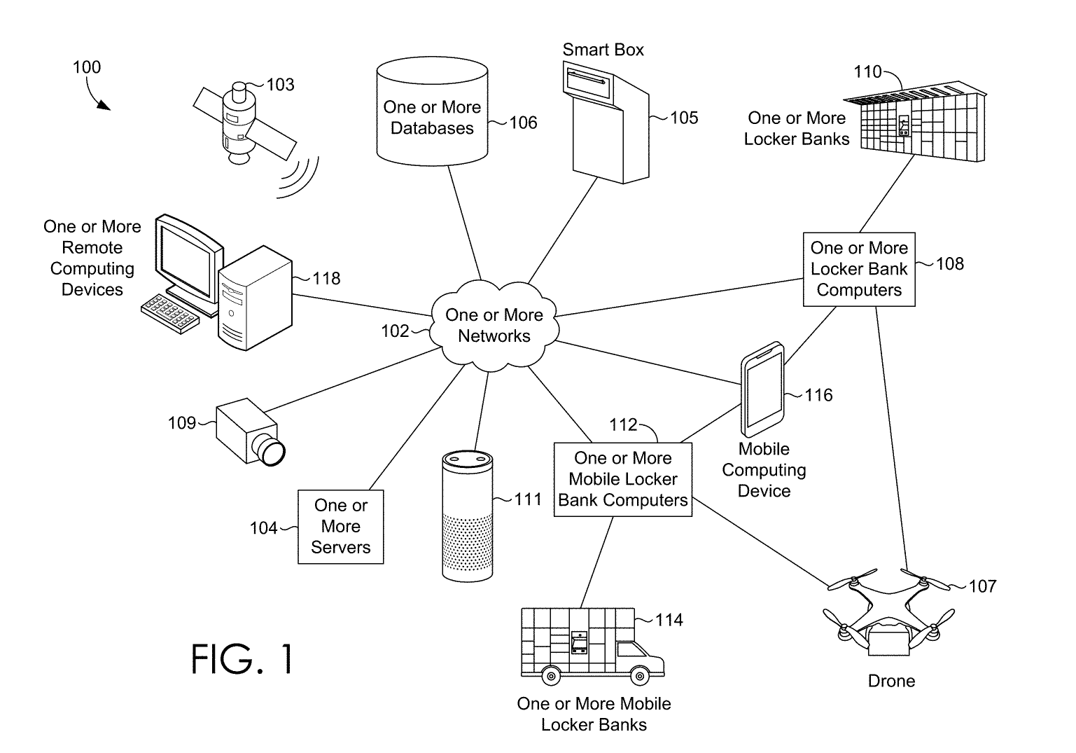

FIG. 1 is a block diagram of an environment 100 according to a particular embodiment. In some embodiments, environment 100 includes one or more computer networks 102, one or more servers 104, one or more databases 106, one or more mobile locker bank computers 112 operatively coupled to one or more mobile locker banks associated with a mobile locker bank 114. As may be understood from this figure, according to some embodiments environment 100 may further include one or more locker bank computers 108 operatively coupled to one or more fixed locker banks 110, one or more mobile computing devices 116, one or more remote computing devices 118 (e.g., a tablet computer, a desktop or laptop computer, or a handheld computing device such as a smart phone), one or more smart boxes 105, one or more satellite 103, one or more virtual assistants 111, and/or one or more unmanned vehicles 107. In particular embodiments, the one or more computer networks 102 facilitate communication between the one or more servers 104, one or more database 106, one or more locker bank computers 108, one or more locker banks 110, one or more mobile locker bank computers 112, one or more mobile locker banks 114, one or more remote computing devices 118, one or more smart boxes 105, one or more satellites 103, one or more virtual assistants 111, and/or one or more unmanned vehicles 107, and the mobile computing device 116. The one or more servers 104 may include one or more remote servers and facilitate the interaction, communication, and routing requirements between the one or more locker bank computers 108 and the one or more mobile locker bank computers 112.

The one or more computer networks 102 may include any of a variety of types of wired or wireless computer networks such as the Internet (or other WAN), a private intranet, a public switch telephone network (PSTN), a mesh network, or any other type of network (e.g., a network that uses Bluetooth (standard or low energy Bluetooth), beacon communication technologies (e.g., iBeacon), and/or near field communications to facilitate communication between computing devices). The communication link between the one or more servers 104, database 106, one or more locker bank computers 108, one or more locker banks 110, one or more mobile locker bank computers 112, one or more mobile locker banks 114, one or more remote computing devices 118, and the mobile computing device 116 may be, for example, implemented via a Local Area Network (LAN) or via the Internet (or other WAN). In particular embodiments, a communication link between the one or more locker bank computers 116, the mobile locker bank computer 112, and the mobile computing device 116 may be implemented via any suitable beacon communication technology (e.g., iBeacon) or any other suitable wireless communication link (e.g., WIFI, Bluetooth, infrared, NFC, IEEE 802.15.4, ZigBee, etc.).

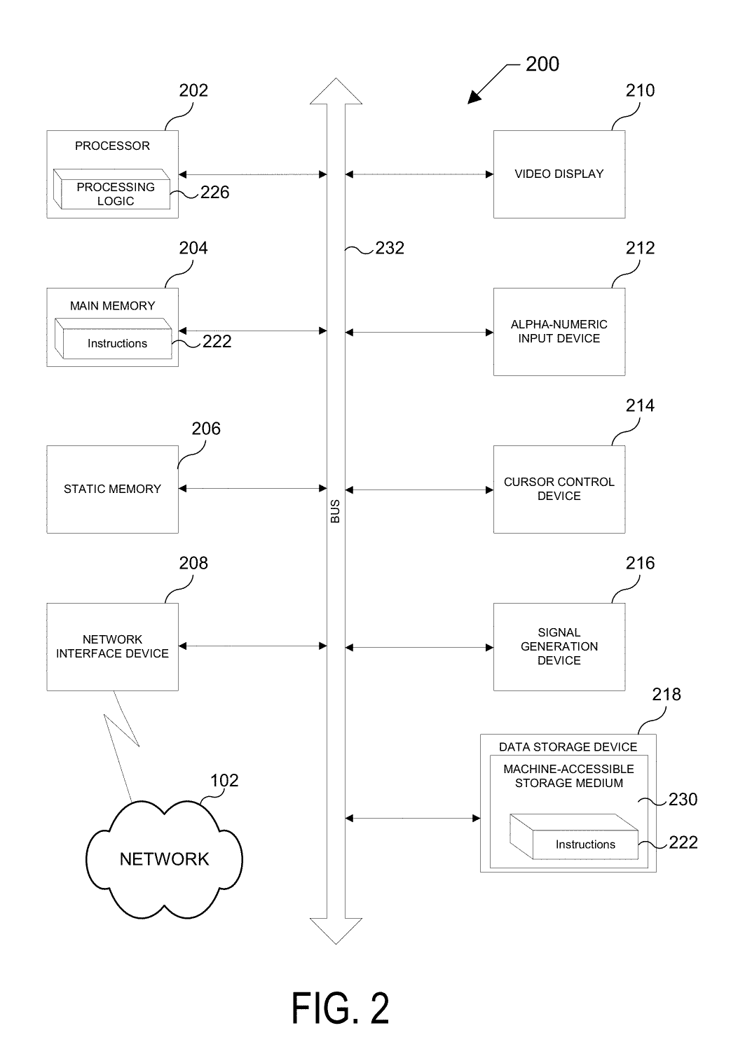

Remote computing devices 118 may include various devices, such as smartphones, smart watches, tablets, personal digital assistants, tablets, laptop computers, digital cameras, mobile device 116, and the like. In some cases, remote computing devices 118 may include devices such as smart mailboxes, smart home appliances, such as a smart refrigerator, or other smart systems that are capable of providing information to a user and collect information from a user. In some embodiments remote computing devices 118 may comprise one or more sensors, such as sensor 109. Sensor 109 may be capable of taking individual images or video. In some cases, remote computing devices 118 may comprise a GUI, which may also be capable of receiving inputs from a user. Remote computing devices 118 may be similar to computing device 200 of FIG. 2. In some cases, remote computing devices 118 may be configured to run apps, or services stored locally and/or on server 104. In some cases, remote computing devices 118 may communicate with other components of environment 100. For example, in one aspect, remote computing devices 118 may be a digital camera that may locally store images, which may be communicated to other computing devices or components, such as server 104 or database 106. Other devices that allow a user to collect information and transmit the information to components of environment 100 may also be considered within the scope of remote computing devices 118. In some instances, remote computing devices 118 may be associated with a customer of a logistics carrier or a party that is receiving a parcel by way of the carrier from the customer.

In some aspects, remote computing devices 118 may comprise an audio component, which may be a component capable of emitting and receiving sound. For example, the audio component may comprise a microphone or a speaker. The audio component may be capable of receiving and emitting a sound detectable by a human. Audio component may further be capable of receiving and emitting sound not detectable by the human ear, but may be detectable by another device or machine.

In some aspects, remote computing devices 118 may further comprise an imagery component. The imagery component may be capable of receiving visual images external to remote computing devices 118. For example, the imagery component may be camera. In some cases, imagery component may be capable of receiving and communicating information corresponding to images that would be visual to the human eye. In some cases, the imagery component may be capable of receiving images from a range or ranges of the electromagnetic spectrum beyond which a human eye is capable of detecting, such as infrared and ultraviolet light. In such cases, the imagery component may convert aspects of the captured images to a human-detectable form and, for example, communicate the converted images to other components of environment 100 or display them on GUI.

In some cases, remote computing devices 118 may comprise a location component. The location component may be capable of determining the location and orientation of remote computing devices 118. Location may be determined by, for example, cell network triangulation, GPS, and the like. In some instances, the location component may similarly determine the location of objects detected by imagery component. The location component may be able to detect and transmit the location of remote computing devices 118 or of an object viewed by the imagery component, and transmit the location to components of environment 100, such as through communications network 102.

In some embodiments, remote computing devices 118 may comprise a display component. The display component may provide visual feedback to a user. In one example, the display component may be GUI. Display component may receive information, for example, from other components within environment 100 or remote computing devices 118, and visually represent the information to the user. In some cases, information displayed may be human readable text or machine readable codes. In some cases, the display component may display individual images or video, for example, images or video that are captured by the imagery component, including real-time display; that are received from computer readable storage media, such as a local store or database 106; or that are received from communications network 102. In some cases, the display component may receive input from the user. For example, the display component may be touch sensitive and detect physical inputs, such as from a person's hand or a stylus. In some cases, the display component may detect various forms of physical touch, such as from different sources, or may detect levels of touch, such as hard or soft.

Environment 100 may sometimes include virtual assistant 111, which may be embodied as a home personal assistant, smart appliance, smart speaker, or the like. Some examples of virtual assistant 111 may include Google Home or Amazon Echo with Amazon Alexa. Virtual assistant 111 may more broadly comprise other computing devices that may access communications network 102. For example, other mobile computing devices, smart appliances (e.g., computer-integrated refrigerators, smart thermostats, smart security systems, home automation systems, and the like), home entertainment systems, vehicles, wearable computing devices, smart doorbells, smart lighting, computerized sensors, or other computing devices that may be characterized as part of the “Internet of Things” (IoT) that are accessible to communications network 102. Using communications network 102, these IoT devices may communicate with components of environment 100 to send and receive information.

In some cases, an app may access other features or apps associated with the customer, such as other features or apps on remote computing devices 118. Some non-exclusive examples of other features or apps may be a customer's contacts list; an electronic calendar; a virtual assistant, such as Apple's Ski or Amazon's Alexa; payment information, which may be used for processing delivery/pickup fees, such as a credit card, bank account, or virtual wallet, and the like. In some instances some, all, or none of the features or apps may be accessed based on customer consent. As an example, a delivery/pickup may be altered based on information received from these features or apps. For example, an unmanned delivery may be scheduled to a customer's home. The delivery may require a signature by the customer or the customer may have requested that parcels not be left unattended at the customer's home. Having access to a customer's electronic calendar, it may be determined that the customer is at his or her office, and not at a home location. Based on this information, an unmanned system, such as UV 107, may deliver the parcel to the customer's office rather than the home location, deliver to a neighbor's home, or withhold delivery until the customer is home, without making an unnecessary trip to the user's home in order to determine the user is not home, which is what happens currently under conventional delivery technologies.

In some embodiments, environment 100 may include mobile computing device 116, an example of which may be a hand-held device carried by a delivery service provider. Mobile computing device 116 may have the same or similar components as those associated with remote computing devices 118. Mobile computing device 116 may be capable of collecting information and communicating to other components of environment 100. In some cases, mobile computing device 116 may read machine readable images, such as bar codes. This may include many types of bar codes, including one-dimensional and two-dimensional bar codes. In some cases, mobile computing device 116 may receive information from machine readable tags, such as radio-frequency identification (RFID) tags. For instance, a parcel may have a bar code or a machine readable tag attached to it. The bar code or tag may have associated identification information that may be interpreted by mobile computing device 116. Further information about the parcel may be stored, for example, on database 106. Mobile computing device 116 may receive information about the parcel and communicate it to, for example, database 106, which may also store other information associated with the parcel, such as logistics notes and the parcel's location. Mobile computing device 116 may further receive information associated with the parcel from database 106, and in some cases, it may display or communicate this information using a GUI or audible communication. Thus, mobile computing device 116 may send and receive logistics information about a parcel, such as when and where the parcel is picked up, where the parcel is located at a given time along a logistics route, and when and where the parcel is delivered. Mobile computing device 140 may receive other information about a parcel, such as its weight, dimensions, special instructions, logistics notes, and shipping priority level. In some cases, mobile device 116 may be associated with a carrier in the business of receiving and delivering parcels from pickup locations to delivery locations.

In some embodiments, environment 100 includes one or more sensors 109. In some embodiments sensor 109 may be one or more imaging systems. An/The imaging system may, for example, be capable of image-mapping or taking images of its surroundings. In some cases, images taken by the imaging system may be two- or three-dimensional images. The imaging system may utilize one or more types of imaging techniques, including images from basic camera systems to more sophisticated systems such as LIDAR, sonar, radar, and the like. The imaging system may take individual still images or may take video imagery. Images and video may be stored in, for example, database 106, or may be transmitted to other components of environment 100 in near real time, for example, guidance component 174. In some embodiments, sensor 109 may comprise a microphone or a speaker. In some embodiments, sensor 109 may comprise physical proximity detectors, such as a touch sensor, touch plate, physical switch, and the like. In some embodiments, sensors 109 may comprise a GPS receiver/transmitter, a GLONASS receiver/transmitter, wireless communication receiver/transmitter, accelerometers, gyroscopes, magnetometers, and/or the like. In some embodiments, one or more sensors 109 may be mounted directly onto and/or integrated into unmanned vehicle 107, mobile locker bank 114, and/or fixed locker bank 110.

Unmanned vehicle (UV) 107 is depicted as an unmanned aerial vehicle (UAV) however this depiction is merely one example of an unmanned vehicle that may be used with environment 100. In FIG. 1, UV 107 is depicted as a four-rotor vertical takeoff and landing drone. However, it is not limited to this type of system. In some instances, UV 107 may comprise other aerial vehicles, terrestrial vehicles, underwater or subterranean vehicles, for example. For embodiments where UV 107 is an aerial vehicle with rotors, any number of rotors may be utilized. For example, UV 107 may be a helicopter having a single, main rotor blade. In some cases, UV 107 may have two, three, four, or more rotors. In some embodiments, UV 107 may be a vertical takeoff and landing drone. In some embodiments, UV 107 may be a fixed wing aircraft, such as those that provide vertical lift using an air foil. UV 107 may be capable of carrying a payload, such as one or more parcels. In some cases, UV 107 may be able to release and retrieve parcels without physical human assistance, such as loading and unloading of a parcel. For example, UV 107 may retrieve a payload from a storage locker associated with a mobile locker bank 114, travel to a release/retrieval area, and release the payload. For another example, UV 107 may retrieve a payload form a release/retrieval area, travel to a mobile locker bank 114, and release the payload.

In some embodiments, UV 107 may communicate with satellite 103. Satellite 103 may provide a means for UV 107 to communicate with other components of environment 100. It is also contemplated that UV 107 may communicate through other communications means, such as cellular, radio, microwave, WiFi, or other wireless communications protocols. As shown in FIG. 1, UV 107 is communicatively coupled to one or more components of operating environment 100 through communications network 102. In some cases, satellite 103 may provide location information to UV 107. Other mechanisms for determining location and altitude may be employed by UV 107 in addition to or instead of satellite 103. Some other nonexclusive examples include using cellular signal triangulation, WiFi access-point location information, image recognition (e.g., identifying landmarks, road signs, other markings, or the using image information), and barometric pressure.

In particular, as noted above, UV 107 may carry or comprise one or more sensors 109. In some cases, the location and direction of UV 107 may further be determined by comparing images from one or more sensors 109 with stored images, for example, on database 106. For example, images received from remote computing devices 118 may be stored on database 106 or transmitted directly to UV 107. In some cases, images received from one or more sensors 109 may be compared in real time to stored images, such as those taken from remote computing devices 118. UV 107 may further determine its location by comparing these images, and may determine additional location information, such as the location of a release/retrieve zone.

In some cases, environment 100 may comprise mobile locker bank 114. Mobile locker bank 114 may be a manned or unmanned vehicle and may coordinate with UV 107 through communications network 102, satellite 103, or both. In some embodiments, UV 107 may be removably docked to mobile locker bank 114. For example, to release/retrieve a parcel to/from a delivery/pickup location, the parcel may be transported over a portion of the route in mobile locker bank 114 and over another portion of the route by UV 107.

It should be understood that environment 100 architecture described with reference to FIG. 1 is an exemplary architecture and other arrangements are contemplated. Further, components of environment 100, for example, remote computing devices 118, mobile computing device 116, or server 104, may be described as or comprise computing devices or systems. An exemplary computing device 200 that may be suitable for components of environment 100 is described now with reference to FIG. 2.

FIG. 2 illustrates a diagrammatic representation of a computing device 200 that can be used within the environment 100, for example, as a client computer (e.g., the mobile computing device 116, the one or more remote computing devices 118, the one or more locker bank computers 108, or the one or more mobile locker bank computers 112 shown in FIG. 1), or as a server computer (e.g., one or more servers 104 shown in FIG. 1). Additionally, computing device 200 may be used within the environment 100, for example, as a remote computing devices 118, and/or mobile device 116. In particular embodiments, the computing device 200 may be suitable for use as a computer within the context of the environment 100 that is configured to facilitate the use of the mobile locker bank as an extension locker bank for holding additional items after a fixed locker bank has reached, or will reach, a threshold capacity. In some embodiments, the computing device 200 may be suitable for use as a computer within the context of the environment 100 that is configure to facilitate the use of the mobile locker bank as an independent locker bank for pickup/delivery of items before arrival and/or after arrival at a pickup/delivery location.

In particular embodiments, the computing device 200 may be connected (e.g., networked) to other computers in a LAN, an intranet, an extranet, and/or the Internet. As noted above, the computing device 200 may operate in the capacity of a server or a client computer in a client-server network environment, or as a peer computer in a peer-to-peer (or distributed) network environment. The computing device 200 may be a personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computing device 200 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232. Additionally, embodiments of exemplary computing device 200 may comprise input/output (I/O) ports, I/O components, and/or a power supply. Although the various blocks of FIG. 2 are shown with lines for the sake of clarity, in reality, delineating various components is not so clear, and metaphorically, the lines would more accurately be grey and fuzzy. For example, one may consider a presentation component such as a display device to be an I/O component. Also, processors may have memory. The inventors recognize that such is the nature of the art, and reiterate that the illustration of FIG. 2 is merely representative of one exemplary computing device that may be used in connection with one or more embodiments of the present technology.

The processing device 202 represents one or more general-purpose processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computing device 200 may further include a network interface device 208. The computing device 200 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-readable storage medium 230 (also known as a non-transitory computer-readable storage medium or a non-transitory computer-readable medium) on which is stored one or more sets of instructions (e.g., software 222) embodying any one or more of the methodologies or functions described herein. The software 222 may also reside, completely or at least partially, within main memory 204 and/or within processing device 202 during execution thereof by computing device 200—main memory 204 and processing device 202 also constituting computer-accessible storage media. The software 222 may further be transmitted or received over a network 102 via network interface device 208.

I/O ports allow computing device 200 to be logically coupled to other devices including I/O components, some of which may be built in. Illustrative components include a microphone, joystick, game pad, satellite dish, scanner, printer, wireless device, and the like. The I/O components may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 200. In some cases, computing device 200 may be communicatively coupled to other devices or components through communications network 102, such as LANs, WANs, cellular networks, the Internet, and the like.

The computing device 200 may be equipped with depth cameras, such as stereoscopic camera systems, infrared camera systems, RGB camera systems, and combinations of these for gesture detection and recognition. Additionally, the computing device 200 may be equipped with one or more sensors 109, such as accelerometers; gyroscopes; magnetometers; and sensing devices, such as sonar, radar, and LIDAR that enable detection of motion. The output of the accelerometers or gyroscopes may be provided to the display of the computing device 200 to render immersive augmented reality or virtual reality.

While the computer-readable storage medium 230 is shown in an exemplary embodiment to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding or carrying a set of instructions for execution by the computer and that cause the computer to perform any one or more of the methodologies of the present invention. The term “computer-readable storage medium” should accordingly be understood to include, but not be limited to, solid-state memories, optical and magnetic media, etc.

### Exemplary Fixed Locker Bank and Mobile Locker Bank

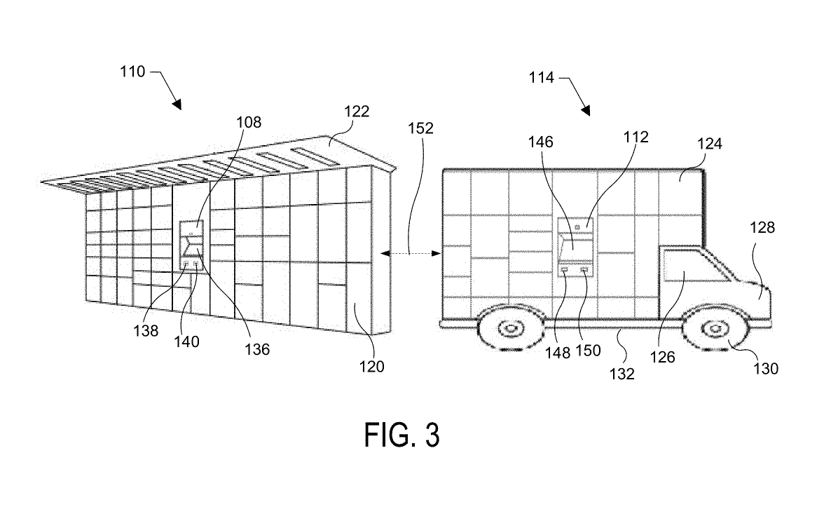

FIG. 3 depicts an exemplary fixed locker bank 110, and mobile locker bank 114, which may be used in facilitating the expansion of the capacity of the fixed locker bank 110. As shown in this figure, the fixed locker bank 110, according to particular embodiments, includes a plurality of lockers 120 of varying sizes (e.g., small, medium, large, etc.). The fixed locker bank 110 may further include an awning 122 that extends outwardly from an upper portion of the fixed locker bank 110 and that may provide at least partial protection to users from various weather conditions such as rain, snow, wind, and sun when the users are placing parcels into the fixed locker bank 110 and/or retrieving parcels from the fixed locker bank 110. Additionally, embodiments of the fixed locker bank 110 may further include a solar panel installation that may provide at least partial power to the fixed locker bank 110, mobile locker bank 114, and/or unmanned vehicles 107 at least temporarily associated with the fixed locker bank 110. In some embodiments the fixed locker bank 110 may provide power to the mobile locker bank 114 and/or unmanned vehicles 107 via wireless charging technology, such as induction charging.

In the embodiment shown in this figure, the fixed locker bank 110 includes a fixed locker bank computer 108 that users may use to facilitate the placement of one or more items into the fixed locker bank 110, for example, in any manner described in this disclosure or in any other suitable manner. The fixed locker bank computer 108, in particular embodiments, comprises a fixed locker bank touch screen display 136 for presenting a user interface for the user to interact with, a fixed locker bank card reader 138 and a fixed locker bank machine-readable indicia scanner 140 (e.g., a barcode scanner). Additionally, the fixed locker bank computer 108 may receive data from one or more sensors, such as sensor 109 that are at least temporarily communicatively coupled to the fixed locker bank computer 108.

The mobile locker bank 114, according to particular embodiments, includes a plurality of lockers 124 of varying sizes (e.g., small, medium, large, etc.). The mobile locker bank 114 further includes a driver compartment 126, an engine 128, a plurality of wheels 130, a powertrain 132, and any other suitable feature for allowing the mobile locker bank to be moveable from one location to another location.

Furthermore, the mobile locker bank 114 includes a mobile locker bank computer 112 that users may use to facilitate the placement of, or retrieval of, one or more items into the mobile locker bank 114. The mobile locker bank computer 112, in particular embodiments, comprises a mobile locker bank touch screen display 146 for presenting a user interface for the user to interact with, a mobile locker bank card reader 148, and a mobile locker bank machine-readable indicia scanner 150 (e.g., a barcode scanner). In some embodiments, the fixed locker bank 110 and/or the mobile locker bank 114 may have all of these features, some of the features, or none of these features. For example, the mobile locker bank may have a mobile locker bank computer 112 that does not include a touch-screen display so that users are required to use the fixed locker bank touch-screen display 136 to gain access to the mobile locker bank lockers 124. In various embodiments, the fixed locker bank touch-screen display 136 and/or the mobile locker bank touch-screen display 146 may display instructions for a user. For example, ether touch-screen may instruct the user on how to enter an access code, how to open and close the locker, how to lock and unlock the locker, etc.

In particular embodiments, the fixed locker bank 110 may be configured to communicate with the mobile locker bank 114 via any suitable communication link, such as, for example, a wired connection 152 or a wireless connection (e.g., Bluetooth, WiFi, Cellular, etc.). In various embodiments, the communication link may be manually established by a user when the mobile locker bank 114 is moved to the location where the fixed locker bank 110 is positioned or it may be automatically established when the mobile locker bank 114 comes within a predetermined distance of the fixed locker bank 110, when the mobile locker bank 114 comes within range of the fixed locker bank 110, or any other suitable criteria is satisfied for automatically establishing the communication link. Automatic wireless connections using Bluetooth, WiFi, and other wireless technology is explained in detail in U.S. patent application Ser. No. 15/252,629, entitled “Locker Banks with Automatically Opening Doors,” filed on Aug. 31, 2016, having Attorney Docket No. 0912/02030, the entire disclosure being incorporated by reference herein.

In various embodiments, the fixed locker bank computer 108 may be in direct or indirect wireless or wired communication with the mobile locker computer 112. For example, when the mobile locker bank 114 is moved to the location where the fixed locker bank 110 is located, the driver may, upon dropping off the mobile locker bank 114, be instructed to connect one or more electrical/communication cables (e.g., wired connection 152) between the fixed locker bank 110 and the mobile locker bank 114. The wired connection 152 may provide a communication channel over which the fixed locker bank computer 108 and the mobile locker bank computer 112 can directly communicate. In particular embodiments, the wired connection 152 may provide power to the mobile locker computer 112, or any other suitable component of the mobile locker bank 114. In various embodiments, the mobile locker bank computer 112 may use the wired connection 152 to gain access to the one or more networks 102 (FIG. 1) in order to communicate with the one or more servers 104 (FIG. 1), the mobile computing device 116 (FIG. 1), or any other suitable device.

In the case of a wireless connection, the fixed locker bank 110 may comprise a WiFi router (e.g., or one or more other suitable wireless access points or antennae) that establishes a local area wireless network at the location of the fixed locker bank 110. Thus, when the driver delivers the mobile locker bank 114 to the location of the fixed locker bank, the system may instruct the driver to connect a wireless receiver (e.g., or other suitable wireless antenna), associated with the mobile locker computer 112, to the local area wireless network established by the WiFi router. In this way, the mobile locker computer 112 can communicate either directly with the fixed locker bank computer 108 or indirectly with the fixed locker bank computer 108 via the one or more servers 104, for example, over the one or more networks 102. Alternatively, the fixed locker bank 110 and the mobile locker bank 114 may each contain any other suitable wireless communication device that is configured to enable the respective computers 108, 112 to communicate directly with the one or more servers 104 or indirectly with one another.

In various embodiments, the fixed locker bank 110 and/or the mobile locker bank 114 may be configured to communicate with a remote computer system (e.g., the one or more servers 104), a combination of a local (e.g., fixed locker bank computer 108) and a remote computer system (e.g., the one or more servers 104), or any other suitable computing systems for the purposes of transferring data (e.g., audio data, input data, video data, image date, etc.). In particular embodiments, the fixed locker bank computer 108 and the mobile locker bank computer 112 are configured to communicate via the one or more networks 102 (FIG. 1) and communicate directly with the one or more servers 104 (e.g., a logistics server). In such embodiments, the communication between the fixed locker bank computer 108 and the mobile locker bank computer 112 may be indirect via the one or more servers 104.

In other embodiments, a fixed locker bank computer may direct the operations of the other fixed locker bank computers and the mobile locker bank computers (e.g., act as an input device for the other computers). Also, a mobile locker bank computer may direct the operations of the other mobile locker bank computers and the fixed locker bank computers. For example, when the mobile locker bank is positioned at the same location as the fixed locker bank and a direct or indirect communication channel is established between the fixed locker bank computer 108 and the mobile locker bank computer 112, input at the fixed locker bank touch screen display 146 may provide instructions for the operation of the mobile locker bank computer 112. Moreover, input at the mobile locker bank touch screen display 146 may provide instructions for the operation of the fixed locker bank computer 108. Thus, in this configuration, when a mobile locker bank 114 is positioned adjacent to a fixed locker bank 110, the combined system may allow two users to interact with the system at the same time. In this way, the fixed locker bank 110 and the mobile locker bank 114 may be controlled by the fixed locker bank computer 108 and/or the fixed locker bank 110 and the mobile locker bank 114 may be controlled by the mobile locker bank computer 112.

In various embodiments, the fixed locker bank 110 and the mobile locker bank 114 may be in proximity to one another, for example, when: (1) the fixed locker bank 110 and the mobile locker bank 114 are located at the same address; (2) the fixed locker bank 110 and the mobile locker bank 114 are within a particular distance of one another; (3) the fixed locker bank 110 and the mobile locker bank 114 are sufficiently closed to enable wireless communication between the two (e.g., the fixed locker bank 110 and the mobile locker bank 114 are within range of respective wireless transmitters, receivers, and or other suitable wireless antennae); etc.

In a particular embodiment, the fixed locker bank 110 and the mobile locker bank 114 each comprise one or more secure lockers 120, 124, respectively, made of a sufficiently strong material to prevent unwanted access to the lockers (e.g., a suitable metal such as steel, steel cage, aluminum, metal alloy, etc.). In various embodiments, the secure lockers 120, 124 of the fixed locker bank 110 and the mobile locker bank 114 comprise any suitable number, size, shape, dimension locker. For example, a particular fixed locker bank may include 25 secure lockers of varying sizes and shapes that are configured to hold a variety of different sized items.

In various embodiments, each of the secure lockers 120 of the fixed locker bank 110 and the secure lockers 124 of the mobile locker bank 114 comprise an enclosure (e.g., a substantially rectangular enclosure or any suitably shaped enclosure) defining at least one opening. In various embodiments, the plurality of lockers each comprise at least one door moveably coupled to the enclosure adjacent the opening for selectively restricting access to the interior of the enclosure. In particular embodiments, the at least one door is positioned to selectively prevent access to the interior of the locker enclosure through the at least one opening when the at least one door is in a first closed position. In various embodiments, the at least one door is configured, when in a second open position, to provide access to the interior of the locker enclosure through the at least one opening. The one or more lockers may have two sidewalls, a top wall, a back wall and a bottom wall. In various embodiments, the bottom wall may be a shared wall between a first locker positioned above a second locker such that the shared wall defines the bottom wall of the first locker and the top wall of the second locker.

The one or more lockers 120 of the fixed locker bank 110 and the one or more lockers 124 of the mobile locker bank 114 each comprise at least one locking mechanism for maintaining the at least one door in a closed position. In particular embodiments, the locking mechanisms are respectively controlled by the fixed locker bank computer 108 and the mobile locker bank computer 112, which may, for example, require an access code (e.g., a PIN, an alphanumeric code, QR code, linear barcode, Maxi code, etc.) in order to unlock a particular locker. The fixed locker bank computer 108 and/or the mobile locker bank computer 112 may control access to each of the one or more lockers 120, 124. In particular embodiments, each particular locker 120, 124, respectively, may be controlled by the fixed locker bank computer 108, the mobile locker bank computer 112, or both the fixed locker bank computer 108 and the mobile locker bank computer 112 (e.g., while the fixed locker bank 110 and the mobile locker bank 114 are in wired or wireless communication with one another).

### Mobile Locker Bank Alternate Embodiments

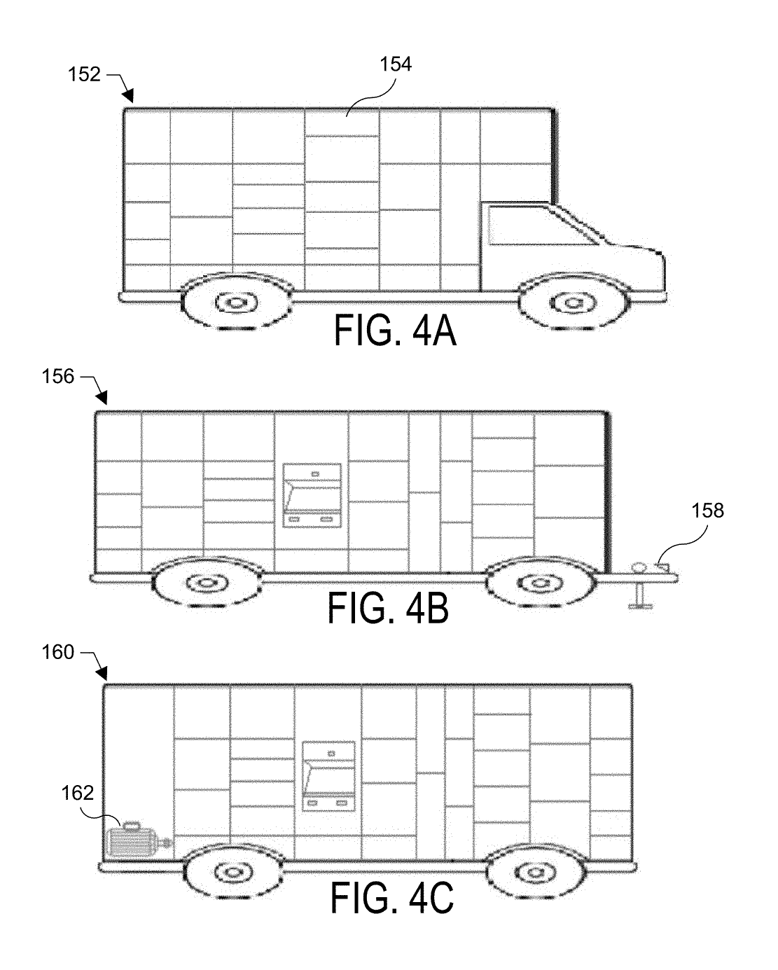

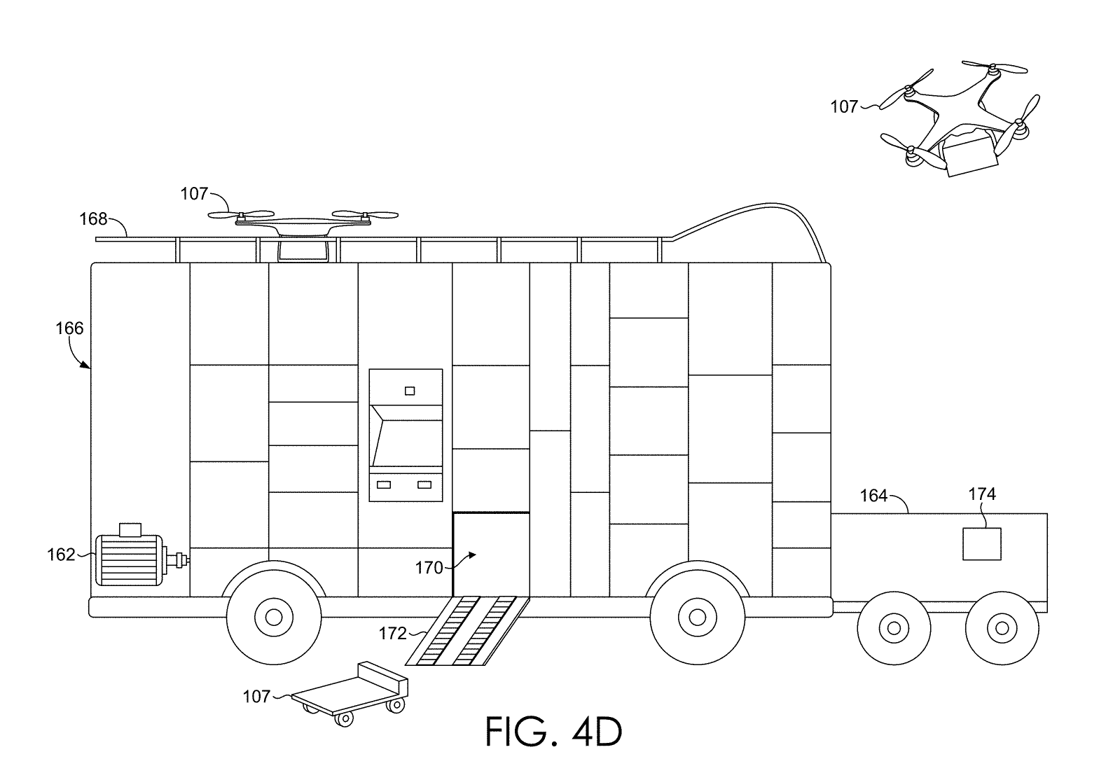

FIGS. 4A-4D show alternative embodiments of the mobile locker bank 114 of FIG. 3. For purposes of ease of understanding and clarity, only certain parts will be discussed to highlight the differences in the structure and operation of the embodiments shown in FIGS. 4A-4D as compared to the embodiment shown in FIG. 3.

Referring to FIG. 4A, a first alternate embodiment mobile locker bank 152 is shown having no visible mobile locker bank computer. Rather, the mobile locker bank computer of the mobile locker bank 152 is enclosed within the mobile locker bank 152, in a position easily accessible by a technician, for instance, but out of view and inaccessible to other users such as customers. The outer portion of the mobile locker bank 152, in this embodiment has instead been replaced with additional lockers 154. This alternate embodiment of the mobile locker bank 152 may be useful in situations where the mobile locker bank will be used in potentially higher crime areas or where it is preferred to have a single touchscreen associated with a fixed locker bank controlling the operation of the mobile locker bank lockers 154 (e.g., input at the fixed locker bank computer drives operation of the mobile locker bank computer).

Referring to FIG. 4B, a second alternate embodiment of a mobile locker bank 156 is shown. In this alternate embodiment, the mobile locker bank 156 lacks an engine, powertrain, and driver compartment. Instead, the mobile locker bank 156 may be coupled to another vehicle via a trailer hitch using any suitable trailer coupler 158 to transport the mobile locker bank 156 to and from a particular location. This alternate embodiment may be beneficial in saving fuel and saving on production costs associated with manufacturing a drivable mobile locker bank.

Referring to FIG. 4C, a third alternate embodiment of a mobile locker bank 160 is shown. In this alternate embodiment, the mobile locker bank 160 is a self-driving mobile locker bank. Therefore, the mobile locker bank does not have a driver compartment. In addition, in various embodiments, the self-driving mobile locker bank 160 may be powered by any suitable gas, electric, and/or hybrid motor 162. This alternate embodiment may be beneficial for saving on labor costs in addition to saving fuel for embodiments using the electric motor 162. Some embodiments of a self-driving mobile locker bank, also referred to as an automated pickup/delivery vehicle or an autonomous pickup/delivery vehicle, may comprise a guidance component 174 and at least one sensor 109. In some embodiments a guidance component 174 may be a standalone computing component, a subcomponent of the mobile locker bank computer 112, and/or a distributed computing component that is included in the overall AP/DV system.

The sensor 109 may include a GPS receiver/transmitter, optical image sensors (such as cameras, video cameras, infrared cameras and the like), LIDAR, sonar, radar, wireless communication receiver/transmitter, accelerometers, gyroscopes, magnetometers, and the like. In some embodiments, the AP/DV system may be communicatively coupled with one, more than one, or a plurality of sensors.

In some embodiments, the AP/DV system may be configured to directly and/or indirectly communicate with one or more servers, such as server 104. For example, the AP/DV system may use a wireless communication receiver/transmitter to communicate with one or more servers. In some embodiments, the AP/DV system may be configured to determine unmanned movement instructions at least partially based on sensor information. For example, an optical image sensor, such as described with reference to sensor 109, may detect a stop sign at a street intersection, and the AP/DV system may generate instructions to engage the autonomous pickup/delivery vehicle's braking system. For another example, the AP/DV system may receive input from the LIDAR, sonar, and/or radar that indicates an obstacle is approaching the front, sides, or back of the autonomous pickup/delivery vehicle and generate instructions to engage steering, braking, accelerating, and/or combinations of the like to avoid the obstacle. Further, the AP/DV system may receive input directly and/or indirectly from one or more servers, satellites (such as satellite 103), mobile devices (such as mobile device 116), remote operating controls, and/or the like.

With reference to FIG. 4D, embodiments of the automated pickup/delivery vehicle (such as self-driving mobile locker bank 160) may comprise a detachable locker bank system 166, such as mobile locker bank 156, and an autonomous driving system 164. In embodiments, the autonomous driving system may comprise an AP/DV system, which could include a guidance component 174, one or more sensors, one or more engines, drive train, powertrain, brakes, steering systems, a coupling system, and the like. Further, as described in reference to FIG. 4B, the detachable locker bank system may comprise one or more sensors and a coupling system (such as coupling system 158) as well. The coupling system of the detachable locker bank 166 and the coupling system of the autonomous driving system 164 may couple with each other. For example, the coupling systems may be a ball and hitch trailer system. However, it will be understood by those skilled in the art that any suitable coupling system capable of coupling the autonomous driving system to the detachable locker bank system may be incorporated in various embodiments.

Further, in some embodiments the AP/DV system may, directly and/or indirectly, be operatively coupled to the coupling system. For example, the AP/DV system may determine that the autonomous pickup/delivery vehicle is located proximate a pickup/delivery location and generate instructions that trigger release/decoupling/unlocking of the autonomous driving system from the detachable locker bank system. As such, a detachable locker bank system 166 may be left, at least temporarily, at a pickup/delivery location while the autonomous driving system 164 moves to a second location. Upon reaching the second location, the AP/DV system may, through one or more sensors, align the coupling system of the autonomous driving system 164 with the coupling system of a second detachable locker bank. The AP/DV system may then generate instructions that trigger attachment/coupling/locking of the autonomous driving system 164 with the second detachable locker bank. As those skilled in the art will understand, such a system may facilitate a single autonomous driving system 164 moving multiple detachable locker banks 166 to various pickup/delivery locations. Further, in some embodiments the detachable locker banks may also couple with each other, thus allowing a single autonomous driving system 164 to move multiple detachable locker banks 166 to a series of one or more pickup/delivery location in a predetermined order; detaching one or more locker banks at a pickup/delivery location and then moving to the next location.

Additionally, some embodiments of the automated pickup/delivery vehicle (such as mobile locker bank 160) may comprise unmanned vehicle pickup/delivery capabilities. For example, the internal portion of the automated pickup/delivery vehicle may comprise storage areas for one or more unmanned vehicles, such as UV 107; charging stations for one or more unmanned vehicles; one or more locker access ports for unmanned vehicle loading/unloading; one or more launch/recovery areas; one or more payload loading/unloading systems; and/or the like. Portions of these subsystems may be combined. For example, the unmanned vehicle storage area may also serve as a charging station. The launch/recovery areas may vary by unmanned vehicle type. For example, a UAV compatible automated pickup/delivery vehicle may comprise a UAV launch hatch 168 and recover system on the roof, rear, sides, and/or front of the automated pickup/delivery vehicle. An unmanned terrestrial vehicle (UTV) compatible automated pickup/delivery vehicle may comprise a swinging door (such as a “doggie door”) 170 and a deployable roll out ramp 172. As may be understood by one skilled in the art, any of the components of each alternate embodiment may be combined with each other and with earlier described embodiments and/or with any other suitable features.

### Exemplary System Platform

Various embodiments of a locker bank having a plurality of lockers and one or more computer systems and a mobile locker bank having a plurality of lockers and one or more computer systems are described above for use in expanding a number of available lockers at the fixed locker bank location. In particular embodiments, these systems may be implemented within the context of any suitable event coordinating system (e.g., Ticketmaster) and/or a computerized locker system such as one offered by a common carrier (e.g., such as United Parcel Service of America, Inc. of Atlanta, Ga.) or other logistic service providers. Various aspects of the system's functionality may be executed by certain system modules, including a capacity determination module 500, guidance component 174, and a fixed locker bank/mobile locker bank locker inventory module 600. These modules are discussed in greater detail below.

It should be understood, in light of this disclosure, that the various functions described below in the context of the capacity determination module 500 and the fixed locker bank/mobile locker bank locker inventory module 600 may be implemented in a manner other than the modular architecture described below. Various embodiments of these functions are described below in this manner to facilitate understanding of the invention described herein. Furthermore, while various embodiments described below may refer to various functions performed by the environment 100, it should be understood that such functions may be performed, in particular embodiments, by any suitable component of, or combination of components of the environment 100, such as those described above with respect to FIG. 1 (e.g., the one or more servers 104, the one or more locker bank computers 108, the one or more mobile locker bank computers 112, the mobile computing device 116, the one or more remote computing devices 118, etc.).

Additionally, although various steps and functions are described as occurring in response to another step, function, or triggering event, it should be understood that in various other embodiments, such functions or steps may occur in response to any other triggering functions or events; independent of any triggering functions or events; at least partially in response to any triggering functions or events; or in response to or at least partially in response to any combination of triggering functions, steps, events, etc. Although these exemplary modules are described as performing these functions in a particular order, it should be further understood that various other embodiments and implementations of these functions may occur in an order other than in which they are presented. Still other embodiments may omit particular steps or functions described below or perform additional steps or functions to those described.

A. Capacity Determination Module

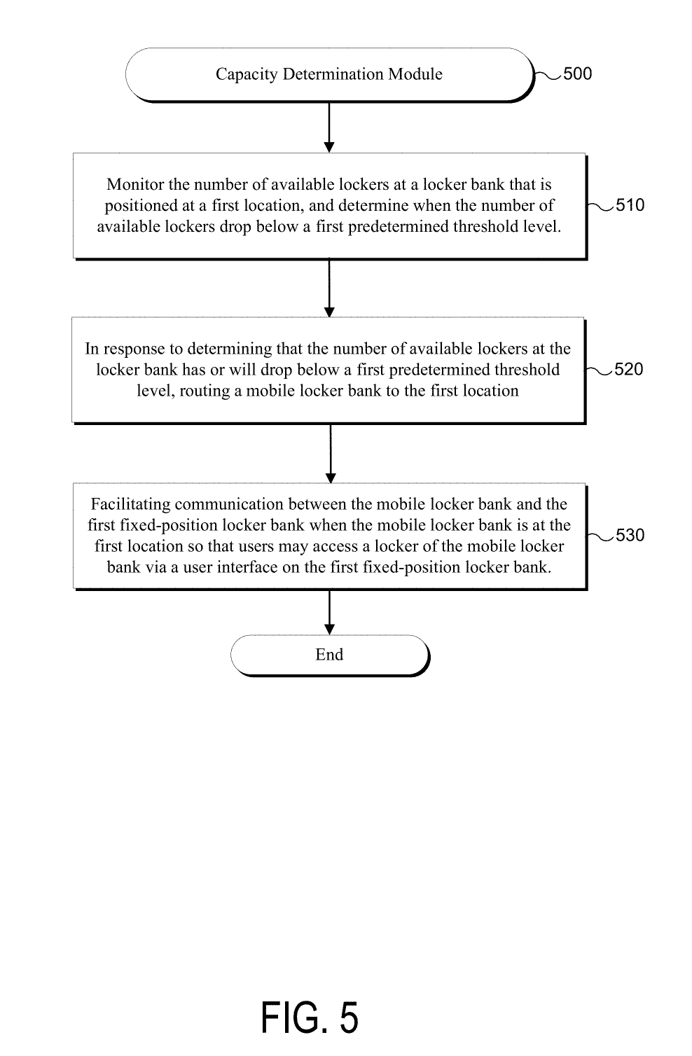

FIG. 5 is a flow chart of operations performed by an exemplary capacity determination module 500 and executed by, for example, the one or more servers 104, the one or more locker bank computers 108, the one or more mobile locker bank computers 112, etc. discussed above with reference to FIG. 1. In particular embodiments, the capacity determination module 500 may facilitate the coordination of routing a mobile locker bank to a fixed locker bank that has or that will reach a threshold capacity. Various steps of an exemplary capacity determination module 500 are described below. Although these steps are discussed in a particular order, it should be understood that particular embodiments of the capacity determination module 500 may include one or more additional steps to those described, may omit one or more of the described steps, or may perform any of the steps in an order other than which they are presented.

I. Monitor the Number of Available Lockers at a Locker Bank that is Positioned at a First Location and Determine when the Number of Available Lockers Drops Below a First Predetermined Threshold Level

Referring to FIG. 5, when executing the capacity determination module 500, the system (e.g., the one or more locker bank computers 112) begins, in various embodiments, at Step 510, by monitoring the number of lockers at a locker bank that is positioned at a first location and determine when/if the number of available lockers drops below a first predetermined threshold level. In various embodiments, the locker bank may be a fixed-position locker bank 110. In some embodiments, the locker bank may be a mobile locker bank 114.

In example embodiments, the system (e.g., the one or more servers 104) may determine a total capacity for the fixed locker bank prior to determining a first predetermined threshold level. For example, the system may determine that a locker bank has 24 lockers available and that the first predetermined threshold level of available lockers is 25%. Thus, when the number of available lockers drops below 6 or is forecasted (e.g., by the one or more serves 104) to drop below 6 lockers, the system determines that the number of available lockers has dropped or will drop below the first predetermined threshold level.

In various embodiments, the system may determine that the total capacity for the fixed locker bank has dropped (e.g., or will drop) below the first predetermined threshold level of available lockers in response to receiving input from a user (e.g., a delivery driver) based on information from the driver on the need to deliver multiple items to the locker bank. In some embodiments, the system may determine that the fixed locker bank has dropped (e.g., or will drop) below the first predetermined threshold level of available lockers based on one or more sensors located within each of the lockers of the fixed locker bank that are configured to detect the presence of an item within the lockers. In various embodiments, the system may determine that the fixed locker bank has dropped (e.g., or will drop) below the first predetermined threshold level of available lockers based on reservation information associated with the fixed locker bank. For example, one or more users may reserve one or more lockers at the fixed locker bank for one or more items to be stored (e.g., prior to the one or more items actually being stored in the one or more lockers), which would potentially cause the number of available lockers at the fixed locker bank to drop below the first predetermined threshold level once the items are placed within the reserved lockers.

In particular embodiments, the system may determine that the fixed locker bank has dropped (e.g., or will drop) below the first predetermined threshold level of available lockers during an inventory forecasting stage for the fixed locker bank. In some embodiments, the predetermined threshold level may be associated with a number of available lockers and/or a number of available lockers of a particular size. Further, a set of thresholds may be used to define the first predetermined threshold level. In example embodiments, the system (e.g., the one or more servers 104) may determine that the fixed locker bank has dropped (e.g., or will drop) below the first predetermined threshold level of available lockers based on analytics used to forecast the number of available lockers at a time in the future. For example, the system (e.g., the one or more servers 104) may determine that a particularly high traffic area is in need of a fixed locker bank and may determine that the particular fixed locker bank will have insufficient available lockers and, as such, a mobile locker bank is necessary in conjunction with the fixed locker bank. In some embodiments, the system may determine that the locker bank has dropped (e.g., or will drop) below the first predetermined threshold level of available lockers in response to receiving a request to deliver a particular number of items to the locker bank. For example, the system may receive a request to deliver baseball tickets to a locker bank located near a baseball field for late pick up by multiple different patrons of the field and the number of ticket groups (e.g., grouped by patron) may exceed the number of available lockers at the locker bank thereby necessitating an expansion of lockers via a mobile locker bank. In various embodiments, the predetermined threshold level of available lockers may be any predetermined level. In particular embodiments, the predetermined threshold level may include that no lockers are available, that a certain number of lockers are available, or that a certain percentage of lockers are available. For example, the system (e.g., the one or more locker bank computers 108) may be configured to determine that the number of available lockers has reached the threshold capacity when 20% of the lockers within the fixed locker bank are available so that the fixed locker bank does not have to turn away customers and/or items if the remaining 80% of the lockers become full before a mobile locker bank is dispatched to the fixed locker bank location. Particularly, the one or more locker bank computers 108 monitor when an item is placed in a locker and the lock is activated. Likewise, the locker is considered unoccupied when the same locker is opened a second time or a sensor provides data that the locker is empty.

In various embodiments, the system may forecast or project parcels to go into the fixed locker bank for a day, week, or other timeframe without regards to any reservation of any locker. The system knows the number of parcels that may be delivered to the fixed locker bank for a given time period. The system can maintain this “virtual” inventory for the forecasted or projected use in addition to the “physical” inventory determined at the fixed locker bank. The virtual inventory is the anticipated use of the fixed locker bank, mobile locker bank, and/or self-driving mobile locker bank with parcels that will be delivered over the day, week, or other timeframe. The physical inventory is the actual number of available and unavailable lockers at any given time at the fixed locker bank, mobile locker bank, and/or self-driving mobile locker bank. Based on the virtual and physical inventories, a determination can be made whether a mobile locker bank is needed, either to supplement the fixed locker bank or to be used in a standalone location. In other words, locker capacity can be tracked based on parcels that are bound for the fixed locker bank, mobile locker bank, and/or self-driving mobile locker bank and parcels that are actually present in the lockers at the fixed locker bank, mobile locker bank, and/or self-driving mobile locker bank. From these known items, a prediction can be made about the locker capacity such as whether to add a mobile locker bank. One benefit from these embodiments is that a mobile locker bank can be arranged for use in advance rather than waiting for available lockers to drop below a threshold at the fixed locker bank. And just as a determination of locker capacity can be made for the fixed locker bank, the system can make a determination of locker capacity for the mobile locker bank in the same manner.

II. In Response to Determining that the Number of Available Lockers at the Locker Bank has or Will Drop Below a First Predetermined Threshold Level, Routing a Mobile Locker Bank to the First Location

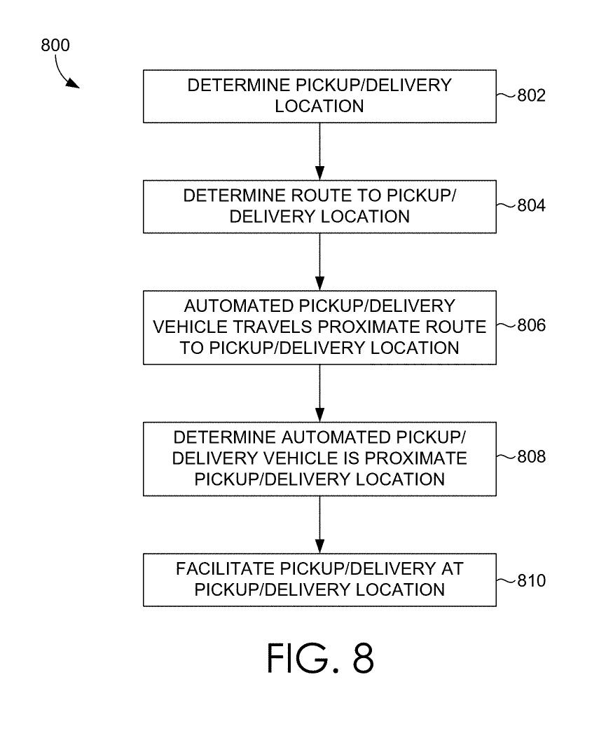

Continuing to step 520, in response to determining that the number of available lockers at the locker bank has dropped below a first predetermined threshold level, the system may route a mobile locker bank to the first location to accept additional items. In various embodiments, the system may route the mobile locker bank to the first location substantially automatically in response to determining that the number of available lockers at the locker bank has/will drop below the first predetermined threshold level. To route the mobile locker bank to the location of the locker bank, the system may notify a particular delivery driver and/or guidance component to drive the mobile locker bank and/or self-driving mobile locker bank to the first location (e.g., the one or more servers 104 may transmit a notification to the mobile computing device 116 associated with the particular delivery driver instructing him or her to drive the mobile locker bank to the first location). In some embodiments, the system may route the mobile locker bank to the location of the locker bank using a self-driving mobile locker bank that is remotely controlled (e.g., or locally controlled by one or more control systems on the mobile locker bank) such as described in reference to FIG. 8. In particular embodiments, the system may route the mobile locker bank to the fixed locker bank to accept additional items by instructing a user (e.g., a delivery driver) to couple a mobile locker bank trailer to a vehicle and tow the mobile locker bank trailer to the location of the locker bank. In a particular embodiment, the system may route the mobile locker bank to the fixed locker bank and/or within unmanned vehicle 107 range of the fixed locker bank to facilitate the transfer of one or more parcels from the fixed locker bank to the mobile locker bank. Additionally, in the event that a mobile locker bank is unavailable for dispatch to a fixed locker bank the system may dispatch other unmanned vehicles, such as UV 107, and/or manned vehicles to the fixed locker bank to transfer one or more parcels from the fixed locker bank to a sorting facility, attended pick/delivery location, a second fixed locker bank, and/or other suitable locations.

In particular embodiments, the system (e.g., the one or more servers 104, and/or guidance component 174) may route the mobile locker bank to a position substantially adjacent the fixed locker bank 110. In various embodiments, the position substantially adjacent to the fixed locker bank may include having one or more sides of the fixed locker bank touch/connect to one or more sides of the mobile locker bank. In some embodiments, the system may route the mobile locker bank to a position within a particular distance of the fixed locker bank. In various embodiments, the system may route the mobile locker bank to a position in proximity to the locker bank that has one or more mounting devices for the mobile locker bank in order to secure the mobile locker bank to the locker bank. In some embodiments, the mobile locker bank may include one or more securing devices (e.g., clamps, locks, bolts, etc.) for securing the mobile locker bank to the locker bank.

III. Facilitating Communication Between the Mobile Locker Bank and the First Fixed-Position Locker Bank when the Mobile Locker Bank is at the First Location so that Users May Access a Locker of the Mobile Locker Bank Via a User Interface on the First Fixed-Position Locker Bank

Continuing at step 530, in various embodiments, after routing the mobile locker bank to the location of the locker bank, the system (e.g., the one or more Servers 104) may instruct a user (e.g., a delivery driver) to establish a wireless or wired connection between the mobile locker bank and the locker bank, as discussed above with reference to FIG. 3. In particular embodiments, the system may instruct the user on how to establish the connection between the mobile locker bank and the locker bank via a mobile computing device associated with the user (e.g., by transmitting one or more instructions to the mobile device 116). For example, when the driver arrives at the location of the locker bank, the mobile computing device 116 may instruct the driver to scan a barcode associated with the locker bank and scan a second barcode associated with the mobile locker bank. The information received from each scanned barcode may then be transmitted from the mobile computing device to the one or more servers 104 (e.g., a logistics server) to associate the plurality of lockers in the mobile locker with the plurality of lockers in the locker bank. In some embodiments, the system may instruct the user on how to establish a connection between the mobile locker bank and the locker bank via the mobile locker bank computer touch screen. In still other embodiments, the system may instruct the user on how to establish the connection between the mobile locker bank and the locker bank via the fixed locker bank computer touch screen.

In various embodiments, the system may instruct the driver of the mobile locker bank using the mobile computing device 116 to connect the mobile locker bank to the locker bank at the location using the cable 152 (FIG. 3). In this way, the cable 152 may provide one or more of power and a communication channel to the mobile locker bank 114. In some embodiments, the fixed locker bank computer 108 may communicate directly with the mobile locker bank computer 112 via the cable 152. In other embodiments, the communication channel may provide the mobile locker bank computer 112 a pathway to communicate directly with the one or more servers 104. In this way, the mobile locker bank computer 112 can communicate indirectly with the fixed locker bank computer 108 via the one or more servers 104.

In various embodiments, when a driver drops off the mobile locker bank 114 at the location of the locker bank, the system may direct the driver to establish a wireless connection between the mobile locker bank 114 and the locker bank by providing directions either on the touch screen display 136 of the fixed locker bank 110, the touch screen 146 on the mobile locker bank 114, or via the mobile computing device 116. For example, in some embodiments, the system (e.g., the one or more servers 104) may direct the driver and/or user to scan a barcode on the fixed locker bank and a barcode on the mobile locker bank. The bar codes may allow the system to look up information about each of the locker bank and the mobile locker bank thereby allowing the system to automatically establish a communication link between the mobile locker bank and the locker bank. For example, the barcode on the locker bank may provide information to the system regarding a WiFi network that is associated with the fixed locker bank thereby allowing the system to cause the mobile locker bank to wirelessly connect to the WiFi network via a WiFi card operatively coupled to the mobile locker bank computer 112.

In other embodiments, the system may instruct the driver to couple the mobile locker bank 114 to the fixed locker bank 110 using the cable 152 in order to provide the mobile locker bank power. Additionally, the system may then instruct the driver via the mobile computing device 116 to establish a wireless connection between the mobile locker bank computer 112 and the fixed locker bank computer 108. In these embodiments, the fixed locker bank and mobile locker bank have both a wireless and a wired connection between one another.

In various embodiments, when the fixed locker bank and mobile locker bank are connected or used together, two approaches can be used to determine locker capacity. In one approach, the system can determine a virtual inventory and physical inventory for the fixed locker bank (as discussed earlier), but also determine a virtual inventory and physical inventory for the mobile locker bank. Consequently, the system would maintain multiple virtual and physical inventories for locker banks, whether fixed or mobile. The system can determine locker capacity for each locker bank using the virtual and physical inventories. From there, the system could merge the inventories or merge the locker capacity determinations to forecast one locker capacity for all the locker banks located together. The idea here is that one or more mobile locker banks might be placed near a fixed locker bank. So, the system can determine locker capacities at a per locker bank level. In another approach, the fixed locker bank and mobile locker bank are treated as one entity. The system determines a virtual inventory and physical inventory for the one entity. Like the capacity determination discussed above for the fixed locker bank using the virtual and physical inventories, a forecast or prediction can be made whether to add an additional mobile locker bank.

B. Fixed Locker Bank/Mobile Locker Inventory Module

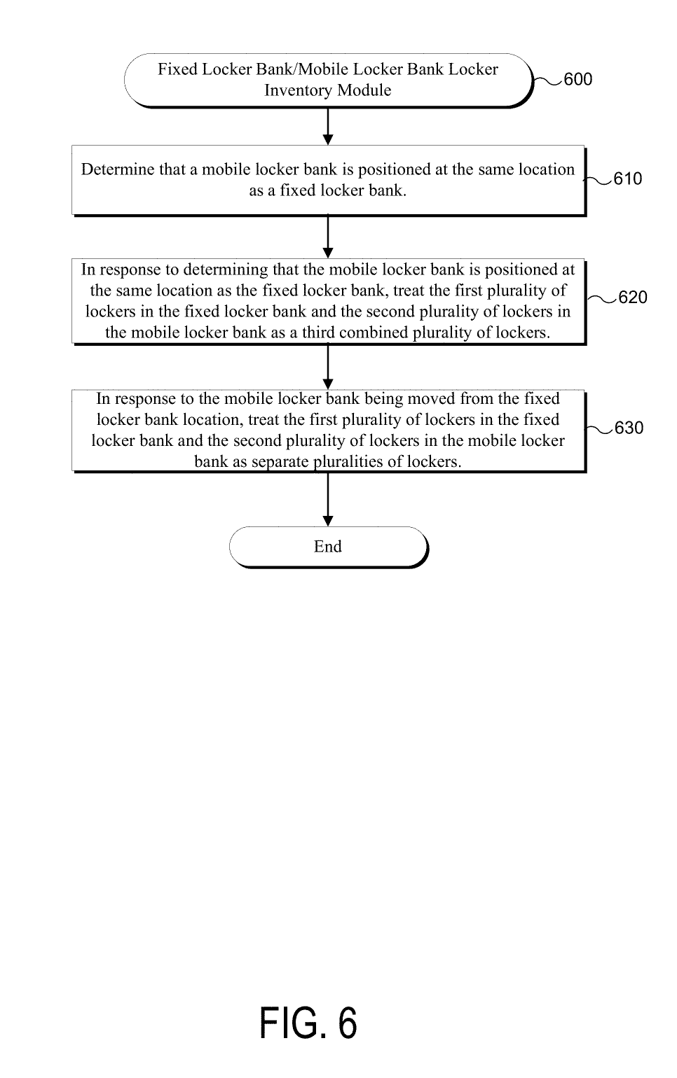

FIG. 6 is a flow chart of operations performed by an exemplary fixed locker bank/mobile locker bank inventory module 600 and executed by, for example, the one or more servers 104, the locker bank computer 108, and/or the mobile locker bank computer 112, as discussed above with reference to FIG. 1. In particular embodiments, the fixed locker bank/mobile locker inventory module 600 may facilitate the system treating a first plurality of lockers at a locker bank and a second plurality of lockers at a mobile locker bank positioned at the same location as the locker bank as a third combined plurality of lockers. Various steps of an exemplary fixed locker bank/mobile locker inventory module 600 are described below. Although these steps are discussed in a particular order, it should be understood that particular embodiments of a fixed locker bank/mobile locker bank communication module 600 may include one or more additional steps to those described, may omit one or more of the described steps, or may perform any of the steps in an order other than which they are presented.

I. Determine that a Mobile Locker Bank is Positioned at a Location Adjacent a Fixed Locker Bank

When executing the fixed locker bank/mobile locker bank inventory module 600, the system begins at Step 610 by determining that a mobile locker bank is positioned at the same location as another locker bank (e.g., a fixed locker bank, a mobile locker bank, an attended/unattended access point, etc.). According to various embodiments, the system may determine that the mobile locker bank is at the same location as the locker bank using any suitable locating technology (e.g., based on GPS coordinates of the mobile computing device, via near field communication (NFC), Bluetooth, or any other suitable wireless communication protocol), by scanning a barcode on the locker bank and on the mobile locker bank, and/or based on a location of the mobile locker bank and/or a delivery vehicle delivering the mobile locker bank (e.g. telematics).

In particular embodiments, the system may determine that the mobile locker bank is at the same location as the locker bank in response to the delivery driver scanning machine-readable indicia (e.g., QR code, linear barcode, Maxi code, etc.) on the mobile locker bank and on the locker bank using the mobile computing device 116. In some embodiments, the system may determine that the mobile locker bank is positioned at the location of the locker bank in response to the delivery driver scanning the machine-readable indicia using a barcode scanner associated with the locker bank computer. In other embodiments, the system may determine that the mobile locker bank is positioned at the location of the fixed locker bank in response to a user connecting the mobile locker bank to the fixed locker bank. For example, once the delivery driver has wirelessly connected the mobile locker bank to the fixed locker bank and/or physically connected a power supply and other cabling from the fixed locker bank to the mobile locker bank, the system determines that the mobile locker bank is now associated with the fixed locker bank.

In particular embodiments, the mobile computing device 116 may be any suitable device such as a mobile computing device, a wireless device such as a smart phone, tablet or other computing device. In various embodiments, the mobile computing device is a device associated with a particular delivery driver. In these embodiments, the mobile computing device may be continuously logged into an application for accessing and providing mobile locker bank location information to a database connected to the one or more servers 104 (e.g., a remote logistics server). In other embodiments, the mobile computing device may automatically connect to the computing device of the locker bank or the mobile locker bank when the mobile computing device is moved within a particular distance from the locker bank computer and/or the mobile locker bank computer.

In still other embodiments, the system may automatically establish a wireless connection between the mobile locker bank computer and the locker bank computer in response to determining that the mobile locker bank is at a location adjacent the fixed locker bank. Suitable methods for automatically establishing a wireless connection (e.g., a direct wireless connection) between computing devices are described in detail in U.S. patent application Ser. No. 15/252,629, entitled “Locker Banks with Automatically Opening Doors,” filed on Aug. 31, 2016, having Attorney Docket No. 0912/02030, the entire disclosure being hereby incorporated by reference. U.S. patent application Ser. No. 15/252,629 particularly describes automatic establishment of wireless connection between a mobile computing device and a locker bank computer. It should be understood that similar techniques may be utilized in the system described herein to initiate wireless connection between a mobile locker bank computer and a locker bank computer.

II. In Response to Determining that the Mobile Locker Bank is Positioned at a Location Adjacent the Fixed Locker Bank, Treat the First Plurality of Lockers in the Fixed Locker Bank and the Second Plurality of Lockers in the Mobile Locker Bank as a Third Combined Plurality of Lockers.

At Step 620, in response to determining that the mobile locker bank is positioned at the same location as the fixed locker bank, the system can treat the first plurality of lockers in the fixed locker bank and the second plurality of lockers in the mobile locker bank as a third combined plurality of lockers. In particular embodiments, when the mobile locker bank is delivered to the location of the locker bank and the system has been notified, the one or more servers 104 may establish a relationship between a database associated with the locker bank and a database associated with the mobile locker bank. That is, each fixed locker bank and each mobile locker bank may have a data structure (e.g., one or more databases 106) associated therewith that is used to track whether a locker in the locker bank is available for use. When a mobile locker bank is delivered to a location where another locker bank (fixed or mobile) is positioned, the system may be configured to link the database of the locker bank with the database of the mobile locker bank so, for purposes of assigning items to a locker, the system treats the totality of available lockers at the location to include both the mobile locker bank lockers and the locker bank lockers.

It should be understood that one of skill in the art would understand that there are other ways to link or concatenate the locker bank database with the mobile locker database so that the system treats the two lockers banks as a single locker bank for the time that the mobile locker bank is at the same location as the locker bank. For example, the one or more servers 104 may expand the locker database to include additional entries to accommodate the additional locker capacity provided by the mobile locker while the mobile locker is positioned at the same location as the locker bank. For example, the database associated with the locker bank may comprise 50 data lines where each data line is linked to a respective locker (i.e., 50 total lockers) in the locker bank. When a mobile locker bank having 25 lockers is delivered to the location where the locker bank is positioned, the system may expand the database associated with the locker bank from 50 data line to 75 data lines to accommodate the expanded capacity provided to the locker bank by the mobile locker bank. For purposes of the system, the system now treats the locker bank as having an expanded capacity of 75 lockers.

In some embodiments, the system also modifies which computing system (e.g., the fixed locker bank computer 108, the mobile locker bank computer 112) controls access to the lockers located within the locker bank and/or the mobile locker bank. For example, linking the database for the locker bank with the database for the mobile locker bank may also cause the system to modify the computer system 112 of the mobile locker bank to disable the touch screen 146 so that users requesting access to one or more lockers of the locker bank and/or the mobile locker bank may use the fixed locker bank touch screen display 136. In this way, the locker bank and the mobile locker bank operate as a single seamless bank of lockers from the perspective of the user. In various embodiments, in response to the system linking the database of the locker bank with the database of the mobile locker bank, when a user accesses the system to reserve a locker at the location, the system may present the user with all of the lockers of the locker bank and the mobile locker bank as a “single” locker bank (i.e., numbered sequentially as if they formed a single locker bank). Thus, from the user's perspective, the locker bank and mobile locker bank appear to be a single bank of lockers.

III. In Response to the Mobile Locker Bank being Moved from the Fixed Locker Bank Location, Treat the First Plurality of Lockers in the Fixed Locker Bank and the Second Plurality of Lockers in the Mobile Locker Bank as Separate Pluralities of Lockers.

At step 630, once it is determined that the mobile locker bank is no longer needed at the location of the fixed locker bank to expand the number of available lockers, the system may instruct a driver to remove the mobile locker bank from the location. When the driver arrives to remove the mobile locker bank, the driver may notify the system that the mobile locker bank is being moved. The drive may notify the system using a mobile computing device. The mobile computing device may be programmed to take the driver through a series of steps for removing the mobile locker bank. In response to this notification, the system may unlink the database associated with the fixed locker bank and the database associated with the mobile locker bank so that the plurality of lockers of the fixed locker bank are treated as a separate plurality from the plurality of lockers associated with the mobile locker bank.

In various embodiments, the system may instruct the driver and/or unmanned vehicles 107 to move items stored within lockers in the mobile locker bank into available lockers in the fixed locker bank. In doing so, the system may update information associated with the items so that the location of the item (e.g., the physical address where they are stored and the actual locker number that they are stored in) is updated in the database associated with the fixed locker bank and/or a database associated with the item. In other embodiments, the system (e.g., the one or more servers 104) may instead determine that the items stored in a locker in the mobile locker bank should remain in the mobile locker bank and be moved to a new location. In this case, the system may unlink the database associated with the mobile locker bank and the fixed locker bank and update information (e.g., tracking information) associated with the item to include new location information as to where the mobile locker bank will be located.

When placing items into the lockers, the system can prioritize placement. For example, the system may consider placement into the fixed locker bank first to minimize the number of packages to be moved if the mobile locker bank is relocated. Also, if the consignee for a particular package has a history of picking up parcels quickly, the system may consider placement of those parcels into the mobile locker bank, since those parcels would only be in the locker for a short time.

C. Unmanned Mobile Locker Pickup/Delivery Location Determination Module

FIG. 8 depicts an exemplary method 800 for facilitating pickup and/or delivery of parcels using an autonomous pickup/delivery vehicle, such as described previously. In some embodiments, the autonomous pickup/delivery vehicle comprises a self-driving mobile locker 160. At a high level, method 800 facilitates pickup and/or delivery of parcels by determining a pickup/delivery location, determining a route to the pickup/delivery location, moving an autonomous pickup/delivery vehicle proximate the route to the pickup/delivery location, determining the autonomous pickup/delivery vehicle is proximate the pickup/delivery location, and facilitating parcel pickup/delivery via the autonomous pickup/delivery vehicle. In some embodiments, portions of method 800 may be performed by a guidance component associated with the automated pickup/delivery vehicle, such as guidance component 174. In an embodiment, portions of method 800 may be facilitated by a server at least temporarily communicatively coupled to the automated pickup/delivery vehicle, such as server 104. In an embodiment, portions of method 800 may be performed by a guidance component and other portions may be performed by a server.

I. Determine at Least One Pickup/Delivery Location for a Mobile Locker Bank

In some embodiments, method 800 begins with block 802 by determining a pickup/delivery location. In general, block 802 relates to determining a geographic location to serve as a pickup/delivery location for the automated pickup/delivery vehicle. The determination of a pickup/delivery location may be based on at least one of a plurality of factors. In an embodiment of block 802, determining a pickup/delivery location may be based on the intended delivery addresses associated with the parcels loaded into the lockers of the automated pickup/delivery vehicle. For example, the intended delivery addresses may be within a neighborhood. In such a case, the pickup/delivery location may be determined to be a central location within the neighborhood. For another example, the intended delivery addresses may be multiple neighborhoods or a geographic region that includes multiple neighborhoods. In such a case the pickup/delivery location may be determined to be a location centrally located between the neighborhoods or centrally located in the geographic region.

In an embodiment of block 802, determining a pickup/delivery location may be based on the density of the intended delivery addresses associated with the parcels loaded into the lockers of the automated pickup/delivery vehicle. In other words, block 802's determination may be weighted based on the number of parcels with an intended delivery address in a subregion of the overall geographic region associated with the parcels loaded into the automated pickup/delivery vehicle. As a non-limiting illustrative example, if the automated pickup/delivery vehicle is loaded with a set of parcels with delivery addresses corresponding to the southwestern region of the neighborhood and a smaller set of parcels with delivery addresses corresponding to the rest of the neighborhood, the pickup/delivery location may be determined to be biased towards the southwestern region of the neighborhood.

In an embodiment of block 802, the pickup/delivery location may be partially based on the population density of the region corresponding to the intended delivery addresses of the parcels loaded into the automated pickup/delivery vehicle. For example, if the region contains multi-occupant buildings (such as apartment buildings, office buildings, duplexes, and the like) and single occupant buildings block 802 may weigh the determination of the pickup/delivery location based on a population density throughout the region such that the pickup/delivery location is closer to the multi-occupant buildings than the single occupant buildings. In an embodiment of block 802, the pickup/delivery location may be based on the density of parking locations. For example, in a highly urbanized area or any area where parking is scarce the roof of a building may serve as a pickup/delivery location. In such a scenario, an aerial automated pickup/delivery vehicle may be dispatched to the pickup/delivery location. Further, in an embodiment of block 802, the pickup/delivery location may be based on the location of fixed locker banks 110, a detachable locker bank system 166, smart drop boxes 105, sorting facilities, and/or attended pickup/delivery locations.

In an embodiment of block 802, determining the pickup/delivery location may be based on legal considerations applicable to the region in which the pickup/delivery location is to be located. For example, a street or a particular side of a street within the region may not be eligible to be a pickup/delivery location because of no parking ordinances and/or no-fly zones. In such a situation, some embodiments of block 802 may eliminate the affected locations within the region from consideration as a pickup/delivery location. Additionally, and/or alternatively, some embodiments of block 802 may alter the availability of specific pickup/delivery features associated with the automated pickup/delivery vehicle to maintain compliance with local laws and ordinances. For example, in an embodiment when the pickup/delivery location is subject to a no-fly ordinance or a temporary no-fly zone, UAV delivery of parcels may be deactivated while the automated pickup/delivery vehicle is at the location/within the area subject to the no-fly ordinance.

In an embodiment of block 802, the pickup/delivery location may be based, or at least partially based, on customer demand. For example, customers may request parcel pickup/delivery services. The customer request may be submitted in any suitable means, such as a logistics provider's website, shipping software, mobile device application, an IoT device, a third-party retailer's website, customer support telephone service, and/or in person request at an attended pickup/delivery location. In some embodiments, the request may comprise relevant information related to the parcel to be picked up or delivered. For example, in some embodiments the request may include at least one of the weight of the parcel, dimensions of the parcel, contents of the parcel, special instructions, logistics notes, shipping priority level, and consent information. In this context, consent information may refer to the shipper's consent for autonomous pickup/delivery services, the customer's consent to the same, and/or the recipient's consent to the same. Further, the customer request may include location information associated with the customer request. In an embodiment, the pickup/delivery location may be based on the population density of the region associated with customer request(s).

In an embodiment for block 802, the pickup/delivery location may be based, or at least partially based, on historic patterns of previously delivered/picked up parcels. For example, customer information may be collected during pickup/delivery and/or during the customer request process that indicates that an alternative (different) pickup/delivery location would be at least partially better suited for a pickup/delivery location in the future. Historic location information may be received from a user device associated with the customer and/or a plurality of user devices associated with a plurality of customers indicating that the customer is regularly located at a given location other than the current pickup/delivery location. For instance, a customer and/or a plurality of customers may regularly travel to/near a specific location before and/or after using the pickup/delivery services provided by the automated pickup/delivery vehicle or other services associated with the logistics provider/company. This information may be stored, at least temporarily, and analyzed to identify patterns of customer travel behavior. The patterns of customer travel behavior may then be used to bias the pickup/delivery location towards the specific location identified.

In an embodiment of block 802, more than one pickup/delivery location may be determined. For example, when the intended delivery addresses associated with the parcels loaded into the lockers of the automated pickup/delivery vehicle are spread through multiple neighborhoods or geographic regions, a first pickup/delivery location may be identified for a first set of the loaded parcels, a second pickup/delivery location may be identified for a second set of loaded parcels, a third pickup/delivery location may be identified for a third set of loaded parcels, and so on. For another example, customer demand may indicate that one pickup/delivery location is needed and the parcels loaded into the lockers associated with the autonomous pickup/delivery vehicle may indicate that another pickup/delivery location is needed. As will be understood by those skilled in the art, the pickup/delivery location may be based on one or more of the factors discussed above. Further, the pickup/delivery location may be based on factors not explicitly discussed herein but that one skilled in the art would understand as relevant for determining pickup/delivery locations.

II. Determine a Route to a Pickup/Delivery Location for a Mobile Locker Bank

In general, block 804 relates to determining a route for the automated pickup/delivery vehicle to travel to a pickup/delivery location. The term “route” is used generically to refer to any path traversed by a manned vehicle, unmanned vehicle, automated pickup/delivery vehicle (such as self-driving mobile locker 160), UV, UAV, UTV, person, animal, and/or the like. In an embodiment, the pickup/delivery location may be the pickup/delivery location determined in block 804. In an embodiment, the route is based on the AP/DV's current location and the pickup/delivery location. For example the current location may be determined by the AP/DV system, a guidance component 174, or another suitable component based on information detected by sensors (such as sensor 109) associated with the AP/DV, and/or satellite 103. For example, the sensors may relay images to the AP/DV system. The AP/DV system may then apply image recognition techniques to geo-locate the AP/DV. For another example, the sensors may relay GPS signal information broadcast by satellite 103 to the AP/DV system. Further, in some embodiments, the AP/DV system may communicate with one or more servers 104 and/or mobile computing device 116 to geo-locate the AP/DV. It will be understood by those skilled in the art that the preceding examples are merely illustrative in nature and further that the AP/DV via the AP/DV system may determine its current location through any suitable means.

In some embodiments, the current location and the pickup/delivery location(s) may be represented in digital maps as being accessible by one or more streets, one or more street networks, or one or more street segments of a street network. A “street network” is a collection of street segments that comprise navigable/traversable/travelable roads, streets, highways, paths, trails, walkways, entrance and exit ramps, bridges, sidewalks, alleys, parking lots, and/or the like that can be used to access pickup/delivery locations. Further, digital maps may include various types of information/data about pickup/delivery locations and street networks, such as the longitude of street segments and/or pickup/delivery locations, the latitude of street segments and/or pickup/delivery locations, the altitude of street segments and/or pickup/delivery locations, the speed limits of street segments, the direction restriction of street segments, time penalties for street segments, address or address range of street segments, current and/or historic vehicle density of street segments, and/or parking restrictions for street segments. In some embodiments, the route may be determined based on the information provided in the digital map. In some embodiments, the route may be, at least partially determined by a human in a remote control center. In some embodiments of block 804, determining the route may be facilitated by a navigation tool communicatively coupled to a guidance component 174. In some embodiments of block 804, determining the route may be determined by the AP/DV system, such as guidance component 174 and/or a remote server 104. Further, in an embodiment, once the route is determined, the route may be presented, by mobile computer device 116 and/or a computer connected to network 102 for verification and/or manual modification.

III. Moving the Mobile Locker Bank Proximate the Route to the Pickup/Delivery Location

In some embodiments, upon determining a route, the AP/DV system generates operational instructions that cause the AP/DV to move, substantially and autonomously, via the route to the pickup/delivery location. In general, block 806 relates to moving the autonomous pickup/delivery vehicle, such as self-driving mobile locker bank 160, to the pickup/delivery location determined in block 802 proximate the route determined in block 804. In some embodiments, the AP/DV system of the autonomous pickup/delivery vehicle (such as self-driving mobile locker bank 160) may operate, directly or indirectly, the drive train, steering, acceleration, deceleration, and the like of the autonomous pickup/delivery vehicle. In some embodiments, the AP/DV system may generate operational instructions to control the movement of the AP/DV. For example, the operational instructions may control the steering, acceleration, deceleration, etc., of the AP/DV so that the AP/DV can move according to the generated route to the determined pickup/delivery location. Further, in some embodiments, the AP/DV system may communicate with and/or interpret information from various sensors 109 incorporated with the autonomous pickup/delivery vehicle to aid in the movement of the automated pickup/delivery vehicle. For example, GPS coordinates may be continuously, periodically, and/or intermittently determined by the AP/DV system to geo-locate the automated pickup/delivery vehicle. For another example, sensor 109 may scan the environment for street signs, addresses, points of interest, or predetermined landmarks to geo-locate the automated pickup/delivery vehicle.

Further, in some embodiments, the route determined in block 806 may be modified during the substantially automatic movement of the autonomous pickup/delivery vehicle from an initial location to the pickup/delivery location. The route may be modified based on context information, such as map information, sensor information, weather information, customer information, and the like. For example, map information may be updated during transit and indicate that traffic on the determined route is heavier than predicted when the route was initially determined. For another example, map information and/or one or more sensors incorporated with and/or in communication with the autonomous pickup/delivery vehicle may indicate a road closure, heavy traffic load, an accident, construction, and/or any other situation that may affect the efficiency of the route determined in block 804. To address this scenario, a particular embodiment of method 800 may return to block 804 and determine an updated route to the pickup/delivery location. For example, the route to the pickup/delivery location may be altered by modifying the selected street(s) and/or street segments included in the route. Such a modification may be a “simple change,” such as modifying the route to avoid an intersection and/or street segment and then returning to the initial route once the situation is avoided. Such a modification may be a “complex change,” such as determining an entirely new route from the current location of the autonomous pickup/delivery vehicle to the pickup/delivery location. Additionally, and/or alternatively, embodiments of block 806 may continuously, periodically, and/or intermittently evaluate the route determined in block 804. In some embodiments such continuous, periodic, and/or intermittent route evaluations may comprise updating and/or reevaluating one or more pickup/delivery locations determined in block 802 based on the contextual information. For instance, customer demand may be monitored in near real-time and may trigger block 806 to return to block 802 for determination of one or more pickup/delivery locations.

In some embodiments, modifying the route may be facilitated by remote human intervention. For example, the autonomous pickup/delivery vehicle may detect a problem on the route and transmit an alert to a remote control station with human operators that the autonomous pickup/delivery vehicle has encountered a routing problem. In such embodiments, one or more human operators may take control of the autonomous pickup/delivery vehicle and remotely control the movement of the autonomous pickup/delivery vehicle. Such remote control may be temporary, periodic, and/or continuous as the situation warrants. Additionally, and/or alternatively, the human operators may manually alter the route. Further, in some embodiments, if one or more sensors indicate a problem while the AP/DV is in transit, an alert may be sent to a remote control station for situational evaluation. For example, if the AP/DV system is delivering navigation instructions but sensor information indicates that the actual movement of the AP/DV does not correspond to the navigation instructions, the AP/DV system may transmit a distress signal to the remote control station.

IV. Determine Mobile Locker Bank is Proximate the Pickup/Delivery Location

Generally, block 808 relates to determining that the automated pickup/delivery vehicle is located at a geographical location proximate the pickup/delivery location. As used herein, a location proximate the pickup/delivery location may include the pickup/delivery location or another location determined as an alternative to the pickup/delivery location that is also suitable for at least a temporary storage of the AP/DV. In some embodiments, the pickup/delivery location may be the pickup/delivery location from block 808. Some embodiments of block 808 may be facilitated by the AP/DV system, such as, for example, a guidance component. In an embodiment, the current location of the automated pickup/delivery vehicle may be determined based on input from one or more sensors, such as sensors 109, associated with the vehicle (for example, a GPS receiver associated with the automated pickup/delivery vehicle, automated driving system, and/or detachable locker bank system). The current location may be determined continuously, periodically, intermittently, and/or at predetermined intervals during automated route navigation. The AP/DV system may then compare the current location, and/or coordinates corresponding to the current location, to the pickup/delivery location, and/or coordinates corresponding to the pickup/delivery location.

In some embodiments, proximate to the pickup/delivery location may mean that the automated pickup/delivery vehicle is located at geographical coordinates corresponding to the determined geographical coordinates for the pickup/delivery location. For example, the pickup/delivery location may correspond to a specific portion of a parking lot, a specific region of a street or street segment, or the like. The location may be reserved for, contracted for, and/or set aside for the placement of the automated pickup/delivery vehicle. For example, a common carrier (e.g. such as United Parcel Service of America, Inc., of Atlanta, Ga.) may contract with a business, city, municipality, property owner, or the like for the right to, at least temporarily, place an automated pickup/delivery vehicle at a predetermined location. For another example, the specific coordinates of the pickup/delivery location may be determined to be the optimal location to position the automated pickup/delivery vehicle. This may be due to the locations proximity to the entrance of a building, ease of pedestrian and/or vehicular access to the location, visual prevalence of the location, and/or the like. It will be understood by those skilled in the art that the preceding list is intended is a nonexclusive exemplary list of the various factors that may govern why the specific coordinates of the pickup/delivery location may be preferred.

In some embodiments this may mean that the automated pickup/delivery vehicle is located within a predetermined distance from the geographical coordinates of the pickup/delivery location from block 802. For example, the automated pickup/delivery vehicle may determine via GPS signals (and/or any suitable means) that the vehicle is within a block, two or more blocks, a mile, two or more miles, or any other predetermined distance from the pickup/delivery location. The automated pickup/delivery vehicle may then begin searching for a suitable location proximate the pickup/delivery location to, at least temporarily, park. In various embodiments, this may be facilitated by one or more sensors associated with the automated pickup/delivery vehicle, a remote human operator, and/or a combination of both.

In some embodiments, as the automated pickup/delivery vehicle approaches the pickup/delivery location, sensors associated with the automated pickup delivery vehicle may attempt to locate suitable locations for the placement of the automated pickup/delivery vehicle. For example, an optical imaging system, sonar, LIDAR, radar, and/or the like, may scan the area surrounding the automated pickup/delivery vehicle to locate available parking, signage on the street that indicates the legality of parking, and/or any obstacles that may prevent parking. In embodiments, as the automated pickup/delivery vehicle continues to approach the pickup/delivery location, the AP/DV system may indicate on a digital map detected locations suitable for the placement of the automated pickup/delivery vehicle. In some embodiments, if upon reaching the coordinates associated with the pickup/delivery location the location is no longer suitable for placement of the automated pickup/delivery vehicle for any reason (e.g., such as a vehicle currently parked at the location; damage to the street, sidewalk, area; pedestrian density prevents safe navigation to the location; indications that the location is not a legal location for placement; presence of inanimate objects such as trash cans, lamp posts, road signs, traffic lights; etc.), the AP/DV system may generate instructions that trigger the movement of the automated pickup/delivery vehicle to a proximate suitable location indicated on the digital map. Additionally, in some embodiments, a location may be determined to be no longer suitable for placement of the automated pickup/delivery vehicle because access to at least one locker, UV dispatch/recovery system, or mobile locker bank computer may be obstructed. For example, sensors 109 may detect a locker door may not be able to open due to the presence of inanimate objects such as trash cans, lamp posts, road signs, traffic lights, and so on.

Additionally, image recognition techniques may be used on information received from sensors associated with the automated pickup/delivery vehicle to determine a pickup/delivery location is not safe for in person pickup/delivery and thus no longer suitable for placement of the automated pickup/delivery vehicle. For instance, downed powerlines may be detected via sensor 109 proximate the pickup/delivery location. While this or other safety issues may not negatively affect the automated pickup/delivery vehicle per se, embodiments of method 800 may nonetheless determine that the pickup/deliver location is, at least temporarily, unsuitable for use. It will be understood by those skilled in the art that this is merely an illustrative example not intended to limit the scope of the embodiments described herein.

In an embodiment, if the pickup/delivery location is no longer suitable for placement of the automated pickup/delivery vehicle, the AP/DV system may send an alert to a remote human operator, who may then assume temporary remote control of the automated pickup/delivery vehicle.

In an embodiment, the digital map may also be provided to the remote human operator. Additionally, in some embodiments, the remote human operator may select a location on the digital map for placement of the automated pickup/delivery vehicle. In some embodiments, the marked suitable locations may be selectable by the remote human operator. Upon indication and/or selection of a location on the digital map, the AP/DV system may generate instructions that trigger the movement of the automated pickup/delivery vehicle to the indicated and/or selected location.

V. Facilitate Parcel Pickup/Delivery Via Mobile Locker Bank

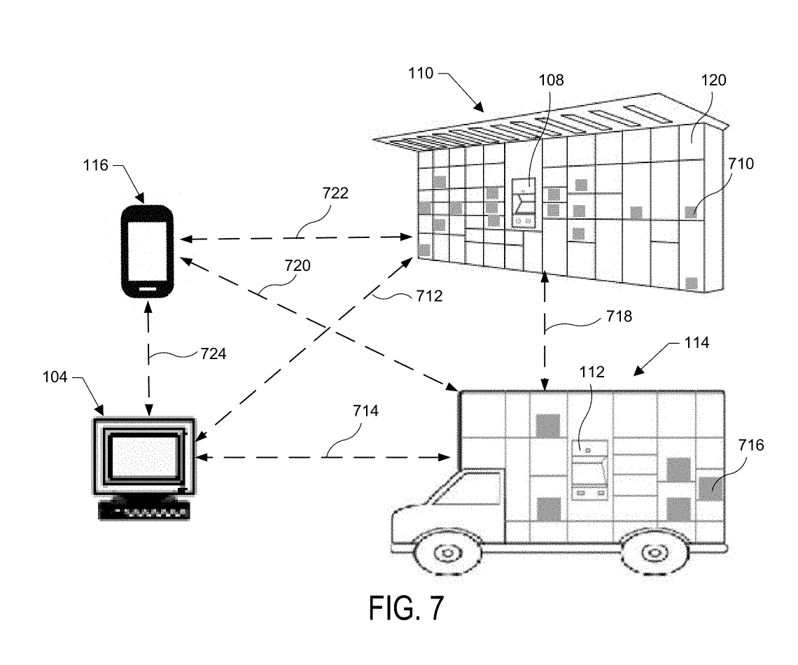

Block 810 facilitates parcel pickup/delivery via mobile locker bank such as an automated pickup/delivery vehicle. According to various embodiments, facilitating parcel pickup/delivery may be facilitated by communications between the automated pickup/delivery vehicle, the locker bank, a logistics provider's server, a common carrier's server, and/or a user device. For example, the pickup/delivery may be facilitated as discussed in reference to FIG. 7. Additionally, in some embodiments an automated pickup/delivery vehicle may send an alert to a user device that includes potential pickup/delivery options. For example, the alert may include options for pickup/delivery by an unmanned vehicle associated with an automated pickup/delivery vehicle), a nearby fixed locker bank, or any other location where an unmanned vehicle may be located. Suitable systems and methods that may be used by an automated pickup/delivery vehicle to communicate with a user device, determine suitability of unmanned vehicle pickup/delivery, dispatch unmanned vehicle(s) to a release/retrieval location, and retrieve/release one or more parcels are described in detail in U.S. patent application Ser. No. 15/643,849, which was filed on Jul. 7, 2017 and entitled “Establishing a Location for Unmanned Delivery/Pickup of a Parcel,” and which is hereby incorporated herein by reference in its entirety.

In some embodiments, the automated pickup/delivery vehicle may pickup/deliver parcels from drop boxes, smart drop boxes, and/or fixed locker banks. For example, the automated pickup/delivery vehicle may detect the location of drop boxes within the range of unmanned vehicles associated with the mobile locker bank and/or self-driving mobile locker bank. The location may be detected directly or indirectly by sensors associated with the mobile locker bank and/or location information provided by one or more servers. The drop boxes may provide information related to parcels present in the drop boxes, such as size, weight, consent, delivery priority, and the like. Further, the drop box may be configured to provide information regarding capacity information of the drop box. Based on the information provided by the drop box, the mobile locker bank may dispatch unmanned vehicles to the location of the drop boxes. Upon arrival, the unmanned vehicles may establish a communication link with the drop boxes. The unmanned vehicle may then coordinate with the drop box to load the unmanned vehicle with the one or more parcels stored in the drop box.

In some embodiments, once loaded the unmanned vehicle may disconnect the communication link between the unmanned vehicle and the drop box. The unmanned vehicle may return to the mobile locker bank and establish a communication link between the unmanned vehicle and the mobile locker bank. The unmanned vehicle and the mobile locker bank may then coordinate capture of the unmanned vehicle. Upon capture, the mobile locker bank and/or the unmanned vehicle may unload the one or more parcels from the unmanned vehicle into a locker of the mobile locker bank. This process may be repeated by the same unmanned vehicle and/or other unmanned vehicles.

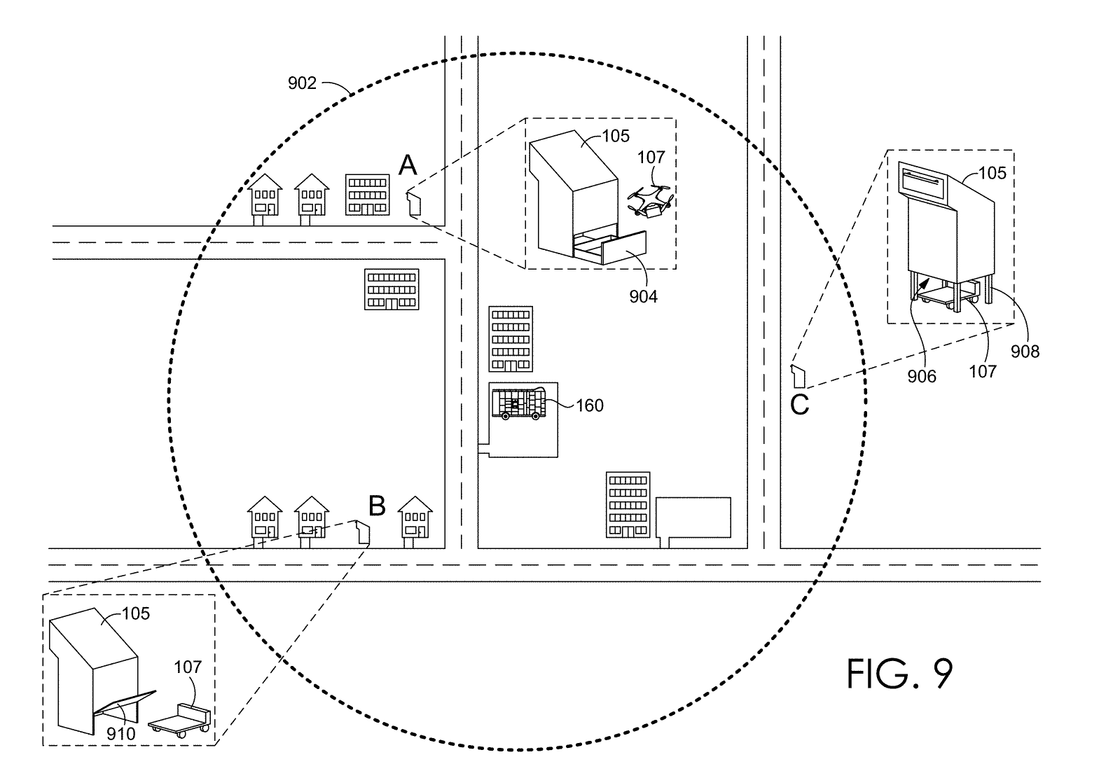

For example, FIG. 9 depicts an illustrative environment 900 of an automated pickup/delivery vehicle at a pickup/delivery location with multiple smart drop boxes within the range 902 of the unmanned vehicle(s) 107 associated with the automated pickup/delivery vehicle 160. The automated pickup/delivery vehicle 160 may detect the locations of the smart drop boxes A, B, and/or C directly or indirectly by sensors 109 and/or location information provided by one or more servers 104. For example, the mobile locker bank computers 112 and/or the AP/DV system may receive geolocation coordinates for the smart drop boxes along the route to the pickup/delivery location and/or a pre-specified distance from the pickup/delivery location. The smart drop boxes may transmit, directly and/or indirectly, information related to the parcels present in the smart drop boxes and the boxes current capacity information to the automated pickup/delivery vehicle 160. For example, the smart box may transmit the size, weight, unmanned vehicle consent, and/or delivery priority associated with each parcel present in the smart drop box. Further, the smart drop box may transmit the current available capacity of the smart drop box.

Based on, at least, the information provided by the smart drop box the automated pickup/delivery vehicle may dispatch unmanned vehicles to the location A, B, and/or C of the smart drop boxes. Upon arrival, the unmanned vehicles may establish a communication link with the drop boxes. For example, automated pickup/delivery vehicle 160 dispatched three unmanned vehicles 107 (one to each location A, B, and C).

The first unmanned vehicle 107 may establish communication with the smart drop box located at location A. In response to the communication, the smart box at location A may position a parcel suitable for unmanned vehicle pickup/delivery in automated sliding tray 904. The smart box may then activate the automated sliding tray 904 to open. The unmanned vehicle may then use sensors 109 and image recognition techniques to locate the parcel on the open sliding tray 904. The unmanned vehicle may then capture the parcel, communicate an indication of a successful capture to the smart drop box 105 at location A, and begin to return to the automated pickup/delivery vehicle 160. Upon receipt of the indication of a successful capture the smart drop box 105 may then activate closure of the automated sliding tray 904.

The second unmanned vehicle 107 may establish communication with the smart drop box located at location B. In response to the communication, the smart box at location B may move a suitable parcel to an automated door 910. The second unmanned vehicle may then align itself with the automated door 910 using sensors, such as sensors 109. Once aligned, the second unmanned vehicle may then transmit a position confirmation to the smart drop box. The smart box may then activate the opening of the automated door 910. Once the automated door 910 is open the parcel may be loaded onto the unmanned vehicle. In some embodiments, the smart box may have an included portion behind the automated door 910 that, once open, urges the parcel onto and/or into the unmanned vehicle. In some embodiments, the smart box may have an automated armature (not depicted) that may guide the parcel onto and/or into the unmanned vehicle. Once the parcel is captured by the second unmanned vehicle, the second unmanned vehicle may communicate an indication of a successful capture to the smart drop box at location B and being to return to the automated pickup/delivery vehicle 160.

The third unmanned vehicle 107 may establish communication with the smart drop box located at location C. In response to the communication, the smart box at location C may move a suitable parcel to hidden loading bay 906 located at the bottom of the smart drop box. In some embodiments, the smart drop box may then activate an automated lifting element 908 which may be configured to raise the smart drop box off of the ground and thereby reveal the hidden loading bay 906. The third unmanned vehicle 107 may then use sensors, such as sensors 109 and image recognition techniques to align itself with the hidden loading bay 906. In some embodiments, the smart drop box may open an automated door that provided the unmanned vehicle with access to the hidden loading bay 906. In such an embodiment, the third unmanned vehicle may use sensors, such as sensors 109, to navigate through the door and into the hidden loading bay 906.

Once aligned, the third unmanned vehicle may then transmit a position confirmation to the smart drop box. The smart drop box may then open the hidden loading bay door(s) and load the parcel onto/into the unmanned vehicle. In some embodiments, the loading bay door(s) may be configured to guide the parcel onto/into the third unmanned vehicle. In some embodiments, the hidden loading bay may have an automated armature (not depicted) that may guide the parcel onto/into the third unmanned vehicle. Once the parcel is captured by the third unmanned vehicle, the third unmanned vehicle may communicate an indication of a successful capture to the smart drop box at location C and being to return to the automated pickup/delivery vehicle 160.

Returning to FIG. 8, in some embodiments, pickup/delivery at a pickup/delivery location may be facilitated for a length of time. The length of time may be predetermined, adjustable, and/or context sensitive. For example, in some embodiments an automated pickup/delivery vehicle may be preprogrammed to accept pickup/delivery requests, and/or unmanned vehicle pickup/delivery requests, at a pickup/delivery location from the time the automated pickup/delivery vehicle arrives at the location until a specified time. For example, the automated pickup/delivery vehicle may be directly or indirectly programmed to allow direct user interaction with a mobile locker bank computer 112 from the time of arrival until noon. At noon, the automated pickup/delivery vehicle may then relocate to a second pickup delivery location. Upon arrival at the second pickup/delivery location, the mobile locker bank computer may reactivate to allow user interaction again until 4:00 PM. This process may repeat again for a third pickup/delivery location, a fourth location, and so on. It will be understood by those skilled in the art that the specific times used are not intended to be limiting, rather they are intended merely as an illustrative example. However, in embodiments, unmanned pickup/delivery may be facilitated throughout the process.

Further, the predetermined time may be a duration of time. For example, pickup/delivery may be facilitated for three hours from the time of arrival at a pickup/delivery location, four hours from the time of arrival at a second location, and so on. It will be understood by those skilled in the art that the specific durations used are not intended to be limiting, rather they are intended merely as an illustrative example.

In some embodiments, the length of time may be adjustable and/or context sensitive. For example, some embodiments may detect the proximity of customers (either for pickup or delivery) and delay departure from a pickup/delivery location. In some embodiments, customers may be detected by sensors associated with the automated pickup/delivery vehicle. In some embodiments, customers may be detected by location information provided by a user device. In some embodiments, a notification may be provided to the user device or the mobile locker bank computer that departure from the pickup/delivery location is imminent, approaching, and/or scheduled. Further, in some embodiments, customer interaction with lockers, the locker bank computer, and/or an application on a user device may temporarily delay departure from a pickup/delivery location. In some embodiments, the automated pickup/delivery vehicle may prompt nearby pedestrians through audio/visual prompts to indicate whether the pedestrians are customers waiting for access to pick up or drop off a parcel to the automated pickup/delivery vehicle. For example, a speaker associated with the automated pickup/delivery vehicle may, or other user interface, ask pedestrians to raise their hands if they are waiting. Sensors associated with the automated pickup/delivery vehicle may then monitor pedestrian reaction. In some embodiments, sensors may detect and directly/indirectly recognize people holding packages. For example, sensors may transmit images to the mobile locker bank computer, one or more servers, and/or one or more remote computers. The image(s) may be processed using image recognition techniques and upon detection of a person with a parcel, departure from the pickup/delivery location may be temporarily delayed. Additionally, and/or alternatively, the system may determine the rate of package drop-offs or pickups and may extend or shorten the length of time, based on this. For instance, where the rate is high (indicating many people are dropping off/picking up), then the length of time may be extended. Conversely, where the rate is low (indicating that not many people are dropping off/picking up), the length of time may be reduced.

In some embodiments, the period of time may be dependent on automated pickup/delivery vehicle information. For example, the AP/DV system and/or remote human operator may receive information from the power supply that indicates a battery is approaching a threshold charge and/or a fuel tank is approaching a threshold volume. The threshold may indicate that the automated pickup/delivery vehicle has enough charge/fuel to return to a sorting facility, or other predetermined location. The AP/DV system and/or remote human operator may adjust, alter, and/or modify the period of time as appropriate. For example, the period may be cut short, features may be selectively deactivated, or the automated pickup/delivery vehicle may travel to a sorting facility or other predetermined location.

Further, in some embodiments, method 800 may additionally comprise providing a notification to customers with parcels loaded into an automated pickup/delivery vehicle. In some embodiments, a notification may be provided to customers with parcels to be delivered to an automated pickup/delivery vehicle. In some embodiments, the notifications may be provided to customers through an application, app, SMS, MMS, an IoT device, remote computing device 118, a virtual assistant 111, and/or any other suitable means. The notification may present information relevant to the customer. For example, the notification may present various pickup/delivery locations an automated pickup/delivery vehicle may be currently located, headed toward, and/or routed to. The notification may present relevant time information (for example, an estimated time of arrival at a pickup/delivery location, an estimated departure time from a pickup/delivery location, and so on).

Further, the notification may present pickup/delivery options available. For example, if the automated pickup/delivery vehicle is equipped for unmanned vehicle pickup/delivery the notification may include a selectable option for unmanned vehicle pickup/delivery. Additionally, in embodiments the notification may present an estimated range for unmanned vehicle pick/delivery, no-fly zones that may interfere with unmanned aerial vehicle pickup/delivery, any applicable charges associated with unmanned vehicle pickup/delivery, and the like. In some embodiments, the notification may be presented on an interactive map which displays part, some, or all of the notification information to a customer.

In some embodiments, the notification may update information intermittently, periodically, and/or continuously. For instance, if an automated pickup/delivery vehicle is damaged, delayed, and/or the route, pickup/delivery locations, and/or pickup/delivery options are modified the notification information may be updated.

### Exemplary User Experience

FIG. 7 depicts an exemplary user experience that may occur in the context of using the system described above to facilitate the expansion of a fixed locker bank by routing a mobile locker bank to a position proximate the fixed locker bank and/or a mobile locker bank operating independently. As discussed with reference to FIGS. 1 and 3, the locker bank system may include a fixed locker bank 110, a mobile locker bank 114, one or more servers 104 (e.g., a logistics server), and (optionally) a mobile computing device 116. In various embodiments, the fixed locker bank 110 and/or the mobile locker bank 114 may have a particular number of lockers 120 and/or 124 respectively. When lockers 120 are housing one or more items 710, the number of available lockers at the fixed locker bank 110 may drop below a predetermined threshold capacity that requires additional lockers for future items. If the threshold capacity is reached, the fixed locker bank computer 108 may communicate with the one or more servers 104 via a first communication channel 712 to request that the mobile locker bank 114 be routed to the fixed locker bank 110 location to accept additional items. The one or more servers 104 may then open a second communication channel 714 between the one or more servers 104 and the mobile locker bank 114. In particular embodiments, the mobile locker bank 114 may already be housing one or more items 716. In some embodiments, the items 716 within the mobile locker bank 114 may be placed there prior to sending the mobile locker bank 114 to the location of the fixed locker bank 110 and/or a pickup/delivery location. For example, in some embodiments one or more items may be loaded into one or more lockers 124 associated with a mobile locker bank 114 (such as an automated pickup/delivery vehicle) In some embodiments, a mobile computing device 116 and/or a mobile locker bank computer 112 may be used to indicate to one or more severs 104 that the one or more items are loaded into lockers associated with the mobile locker bank 114, 152, 156, 160, and/or 168.

Once the mobile locker bank 114 arrives at the location of the fixed locker bank 110 and/or a pickup/delivery location, the system may instruct the driver and/or AP/DV system to establish a wireless communication connection between the mobile locker bank 114 and the fixed locker bank 110 via any suitable wireless connection 718 (such as those described herein), which includes a third communication channel and/or physical components for connecting the mobile locker bank 114 to the fixed locker bank 110, as described above. This allows the mobile locker bank 114 and the fixed locker bank 110 to operate as a unified locker bank. For example, a user submitting a request via a mobile computing device 116 (e.g., a smart phone) to deposit an item into a locker at the location of the mobile locker bank 114 and/or the fixed locker bank 110 may be presented with a graphical display of the available lockers within both the mobile locker bank 114 and the fixed locker bank 110. In various embodiments, the display may indicate which lockers are part of the mobile locker bank 114 and which lockers are part of the fixed locker bank 110. In particular embodiments, the display may simply indicate which lockers are available without differentiating between the mobile locker bank 114 and the fixed locker bank 110.

In receiving the request from the user, the mobile computing device 116 may open a wireless communication connection directly with the mobile locker bank 114 via a fourth communication channel 720 and/or a wireless communication channel with the fixed locker bank 110 via a fifth communication channel 722. In particular embodiments, the mobile computing device 116 may, instead, communicate with the one or more servers 104 via a sixth communication channel 724 in order to submit the request and/or to access a database containing the unified locker bank information such as configuration, capacity information, etc. In various embodiments, the user may also use either the fixed locker bank computer 108 or the mobile locker bank computer 112 to request to deposit an item within either the fixed locker bank 110 or the mobile locker bank 114.

In various embodiments, a user (e.g., a delivery driver, customer, consignee, and/or consignor) may arrive at a location to deposit/retrieve a parcel with both a fixed locker bank 110 and a mobile locker bank 114 and/or a location with a mobile locker bank 114. The user may then use the fixed locker bank computer 108 to pickup/deliver the parcel by, for example, using the fixed locker bank computer 108 and/or mobile locker bank computer 112 to request to pickup/deliver the parcel (e.g., by scanning a machine-readable indicia associated with the parcel using a machine-readable indicia scanner at the fixed locker bank computer 108 and/or mobile locker bank computer 112). The system (e.g., the one or more servers 104) may then determine that there is an available locker and/or the locker in which the parcel is located in the fixed locker bank 108 and/or mobile locker bank 114. The fixed locker bank computer 108 and/or mobile locker bank computer 112 may then cause the available locker and/or the locker in which the parcel is located to open (e.g., by disengaging a locking mechanism associated with the locker). The user can then place the parcel in the locker and/or remove the parcel from the locker. The locker bank computer and/or mobile locker bank computer may then update the logistics information associated with the one or more items. Suitable systems and methods that may be used for conveying a parcel to a locker bank and/or mobile locker bank are described in detail in U.S. patent application Ser. No. 14/514,000, which was filed on Oct. 14, 2014, and entitled “Systems and Methods for Conveying a Parcel to a Consignee, for Example, After an Unsuccessful Delivery Attempt,” and which is hereby incorporated herein by reference in its entirety. Moreover, suitable systems and methods that may be used for confirming the identity of a user at a locker bank (e.g., such as a user retrieving a parcel from the locker bank) are described in detail in U.S. patent application Ser. No. 14/514,276, which was filed on Oct. 14, 2014, and entitled “Systems and Methods for Confirming an Identity of an Individual, for example, at a Locker Bank”, and which is hereby incorporated herein by reference in its entirety. Finally, suitable systems and methods that may be used for facilitating the opening of an appropriately sized locker at a locker bank and/or mobile locker bank are described in detail in U.S. patent application Ser. No. 14/514,155, which was filed on Oct. 14, 2014, and entitled “Systems and Methods for Facilitating Delivery of a Parcel to Suitably-Sized Locker”, and which is hereby incorporated herein by reference in its entirety.

Additionally, and/or alternatively, in an embodiment a user may use a remote computing device 118, and/or a virtual assistant 111, to communicate with the fixed locker bank computer 108 and/or mobile locker bank computer 112 directly/indirectly (such as via an app, website, network 102, and the like) to pickup/deliver the parcel via an unmanned vehicle 107. The fixed locker bank computer 108 and/or mobile locker bank computer 112 may then determine the availability of locker space and/or determine the location (e.g. locker identification) of the parcel in the locker bank and/or mobile locker bank. In some embodiments, the fixed locker bank computer 108 and/or mobile locker bank computer 112 may coordinate with the user through the remote computing device 118 and/or a virtual assistant 111 for pickup/delivery of the parcel. Suitable methods, systems, and processes for establishing suitability of unmanned vehicle delivery of parcels, facilitating communication between a remote computer device and/or virtual assistant and a locker bank computer and/or a mobile locker bank computer are described in detail in U.S. patent application Ser. No. 15/643,849, which was filed on Jul. 7, 2017, and entitled “Establishing a Location for Unmanned Delivery/Pickup of a Parcel,” and which is hereby incorporated herein by reference in its entirety.

Many modifications and other embodiments of the invention will come to mind to one skilled in the art to which this invention pertains having the benefit of the teachings presented in the foregoing descriptions and the associated drawings. While examples discussed above cover the use of various embodiments in the context of expanding the capacity of a fixed locker bank, various embodiments may be used in any other suitable context. For example, particular embodiments of the system may be utilized in expanding the capacity of a mobile locker bank. Therefore, it is to be understood that the invention is not to be limited to the specific embodiments disclosed and that modifications and other embodiments are intended to be included within the scope of the appended claims. It should also be understood that, although various events are described above as occurring “in response to” certain triggering occurrences, those events may occur in response to only those occurrences or a combination of the triggering occurrences and other occurrences. Although specific terms are employed herein, they are used in a generic and descriptive sense only and not for the purposes of limitation.

What is claimed is:

1. An automated pickup/delivery vehicle (AP/DV) system for facilitating autonomous delivery/pickup, the AP/DV system comprising:
a first locker bank comprising at least a first pickup/delivery locker; and
a processor having computer executable instructions that, when executed by the processor, cause the AP/DV system to perform operations comprising:
determining a first pickup/delivery location associated with a first parcel to, at least temporarily, locate an AP/DV associated with the AP/DV system, wherein the determining of the first pickup/delivery location is at least partially based on location information of a customer associated with the first parcel,
determining a current location of the AP/DV,
generating a first route to the first pickup/delivery location based on at least the current location of the AP/DV and the first pickup/delivery location associated with the first parcel,
generating a first set of operational instructions to control operation of the AP/DV for moving the AP/DV to the first pickup/delivery location based, at least partially, on the first route, and
determining that the AP/DV is located at a geographic location proximate the first pickup/delivery location.

2. The AP/DV system of claim 1 wherein the first set of operational instructions cause the AP/DV to move from the current location to the geographic location proximate the first pickup/delivery location.

3. The AP/DV system of claim 1, wherein the computer executable instructions further cause the AP/DV system to perform operations comprising:
transmitting an alert to a user device associated with the customer in response to the determining that the AP/DV is proximate the first pickup/delivery location.

4. The AP/DV system of claim 1, wherein the AP/DV system further comprises at least one of an unmanned aerial vehicle or an unmanned terrestrial vehicle.

5. The AP/DV system of claim 4, wherein the at least one of the unmanned aerial vehicle and the unmanned terrestrial vehicle is configured to:
pickup at least one parcel from a pickup/delivery locker; and
deliver the at least one parcel to a delivery location.

6. The AP/DV system of claim 4, wherein the at least one of the unmanned aerial vehicle and the unmanned terrestrial vehicle is configured to:
pickup at least one parcel from a pickup location; and
load the at least one parcel into a pickup/delivery locker.

7. The AP/DV system of claim 4, further comprising a launch/recovery component configured to launch and recover the unmanned aerial vehicle or the unmanned terrestrial vehicle.

8. The AP/DV system of claim 1, wherein the first locker bank further comprises:
a locking system that is adapted to selectively lock/unlock the first pickup/delivery locker; and
a computing system comprising a user interface operatively coupled to the locking system and for communicating information to the customer, wherein the computing system is adapted to control access to the first pickup/delivery locker based on input received via the user interface.

9. The AP/DV system of claim 1, wherein the AP/DV is operatively coupled to a coupling system that is adapted to selectively couple/uncouple locker banks from the AP/DV, and wherein the computer executable instructions further cause the AP/DV system to perform operations comprising:
at least partially in response to determining that the AP/DV is located proximate the first pickup/delivery location, transmitting a first signal to the coupling system to uncouple the first locker bank from the AP/DV.

10. The AP/DV system of claim 9, wherein the computer executable instructions further cause the AP/DV system to perform operations comprising:
generating a second route to a second pickup/delivery location;
generating a second set of operational instructions to control operation of the AP/DV for moving the AP/DV to the second pickup/delivery location based, at least partially, on the second route; and
determining that the AP/DV is located at a geographic location proximate the second pickup/delivery location.

11. The AP/DV system of claim 10, further comprising:
a second locker bank comprising at least a second pickup/delivery locker, wherein the computer executable instructions further cause the AP/DV system to perform operations comprising:
at least partially in response to determining that the AP/DV is located proximate the second pickup/delivery location, transmitting a second signal to the coupling system to couple the second locker bank to the AP/DV.

12. The AP/DV system of claim 10, further comprising:
a second locker bank comprising at least a second pickup/delivery locker, wherein the computer executable instructions further cause the AP/DV system to perform operations comprising:
determining that the AP/DV is located proximate the second pickup/delivery location; and
at least partially in response to determining that the AP/DV is located proximate the second pickup/delivery location, transmitting a second signal to the coupling system to uncouple the second locker bank from the AP/DV.

13. A system for facilitating autonomous delivery/pickup by an unmanned vehicle, the system comprising:
an automated pickup/delivery vehicle (AP/DV) comprising at least a first locker bank, wherein the first locker bank comprises a first set of pickup/delivery lockers;
one or more processors; and
computer memory having instructions that, when executed by the one or more processors, cause the one or more processors to perform operations comprising:
determining a first set of parcels to be stored in the first set of pickup/delivery lockers;
receiving an indication that the first set of parcels is stored in the first set of pickup/delivery lockers;
determining a first pickup/delivery location associated with a first parcel to, at least temporarily, locate the AP/DV, wherein the first pickup/delivery location is based on location information of a customer associated with the first parcel;
generating, based on the first pickup/delivery location, a first route to the first pickup/delivery location;
determining a context associated with the first route;
based on the context and the first route, generating operational instructions to control operation of the AP/DV for moving the AP/DV to the first pickup/delivery location; and
determining that the AP/DV is located at a geographic location proximate the first pickup/delivery location.

14. The system of claim 13, wherein the instructions further cause the one or more processors to perform operations comprising:
receiving a third indication that the first set of parcels is no longer loaded into the first set of pickup/delivery lockers; and
determining, at least partially based on the first pickup/delivery location, a second route to a second pickup/delivery location.

15. The system of claim 13, wherein the instructions further cause the one or more processors to perform operations comprising communicating to a user device a notification that the AP/DV is located at the first pickup/delivery location.

16. The system of claim 13, wherein the determining of the pickup/delivery location is based, at least in part, on at least one of:
a density of intended delivery addresses associated with parcels loaded into the first set of pickup/delivery lockers of the automated pickup/delivery vehicle;
a population density of a region corresponding to the intended delivery addresses of the parcels loaded into the automated pickup/delivery vehicle; and
location information associated with at least one customer request.

17. The system of claim 13, wherein the instructions further cause the one or more processors to perform operations comprising:
determining at least a second pickup/delivery location, wherein the first route further comprises the second pickup/delivery location.

18. A method for facilitating automated delivery/pickup by an automated pickup/delivery vehicle (AP/DV) comprising a first pickup/delivery locker and a location sensor, the method comprising:
receiving a first indication that a first parcel is stored in the first pickup/delivery locker;
determining a first pickup/delivery location to, at least temporarily, locate the AP/DV, wherein the determining of the first pickup/delivery location is at least partially based on a location associated with the first parcel;
determining a current location of the AP/DV based on data received from the location sensor;
generating a first route to the first pickup/delivery location based on the current location of the AP/DV and the first pickup/delivery location;
generating operational instructions to control operation of the AP/DV for moving the AP/DV to the first pickup/delivery location based, at least partially, on the first route; and
determining that the AP/DV is located at a geographic location proximate the first pickup/delivery location.

19. The method of claim 18, further comprising:
unlocking the first locker to enable pickup/delivery of the first parcel.

20. The method of claim 18, further comprising:
facilitating transfer of the first parcel from the first locker to an unmanned delivery vehicle for delivery of the first parcel.
